(19) United States
(12) Patent Application Publication
(10) Pub. No.: US 2004/0044739 A1
(43) Pub. Date: Mar. 4, 2004

(54) System and methods for processing PIN-authenticated transactions

(76) Inventor: Robert Ziegler, Southlake, TX (US)

Correspondence Address: HOWISON & ARNOTT, L.L.P, P.O. BOX 741715, DALLAS, TX, 75374-1715, US

(21) Appl. No.: 10/264,762

(22) Filed: Oct. 4, 2002

Related U.S. Application Data
(60) Provisional application No. 60/408,122, filed on Sep. 4, 2002.

(51) Int. Cl. G06F 17/60; G06F 15/167

(52) U.S. Cl. 709/213; 705/43

(57) ABSTRACT

A PIN authenticated transaction is performed by collecting representational data from a terminal. The representational data is then transmitted from the terminal to a PIN processor where the representational data is processed to generate a PIN. The transaction is then authenticated using the generated PIN.

### FIELD OF THE INVENTION

This invention relates to the field of transaction protocols, in particular for processing financial transactions over the Internet.

### BACKGROUND OF THE INVENTION

92% of all transactions on the Internet are conducted with credit cards. A number of problems arise in the use of credit cards, both from the perspective of the customer and the merchants. One of the most serious problems for many on-line merchants comes from the fact that credit card transactions can be reputed with a single phone call. One of the reasons why Internet credit card transactions can be reputed so easily and effectively is that the customer is never authenticated. Particularly where services are concerned, the inability to verify the identity of the customer is a serious flaw in the nature of on-line credit card transactions.

On the other hand, ATM or Debit card transactions, where the transaction has been verified with a PIN can not be reputed. By including PIN entry in a transaction, the identity of the customer can be authenticated. However, the EFT network is governed by rules designed to safeguard the various parties in an ATM transaction. In particular, the security of the PIN is subject to strict controls. Most proposals to introduce the advantages of ATM transactions to the on-line environment, however, fail to adequately protect the PIN from being compromised.

Some solutions approach the PIN security issue by proposing the introduction of additional secure hardware and/or additional communication routes to every customer computer. These types of solutions introduce costs to the system that will be an obstacle to widespread acceptance of the solution by the general public.

What is needed, therefore, is a system and method of providing secure PIN-based transactions over the Internet without requiring additional hardware or communication lines for the customer.

### SUMMARY OF THE INVENTION

A PIN authenticated transaction is performed by collecting representational data from a terminal. The representational data is then transmitted from the terminal to a PIN processor where the representational data is processed to generate a PIN. The transaction is then authenticated using the generated PIN.

### BRIEF DESCRIPTION OF THE DRAWINGS

Other objects and advantages of the invention will become apparent upon reading the following detailed description and upon referencing the accompanying drawings, in which:

FIG. 1 is a schematic showing a network-based system for processing transactions;

FIGS. 2a-2c are a flowchart representing a PIN-authenticated financial transaction;

FIG. 3 is a representation of a merchant web-site payment select screen;

FIG. 4 is a representation of an ATM web-site data entry screen;

FIG. 5 is a representation of four randomized graphical keypads;

FIGS. 6a and 6b are a flowchart of the dynamic delivery process;

FIG. 7 is a flowchart of the process monitoring;

FIG. 8 is a flowchart of the terminal communication;

FIG. 9 is a flowchart of the version check process;

FIG. 10 is a flowchart of the compliation security process;

FIG. 11 depicts the ATM secure server; and

FIG. 12 is a functional diagram of the ATM session software.

### DETAILED DESCRIPTION OF THE DRAWINGS

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

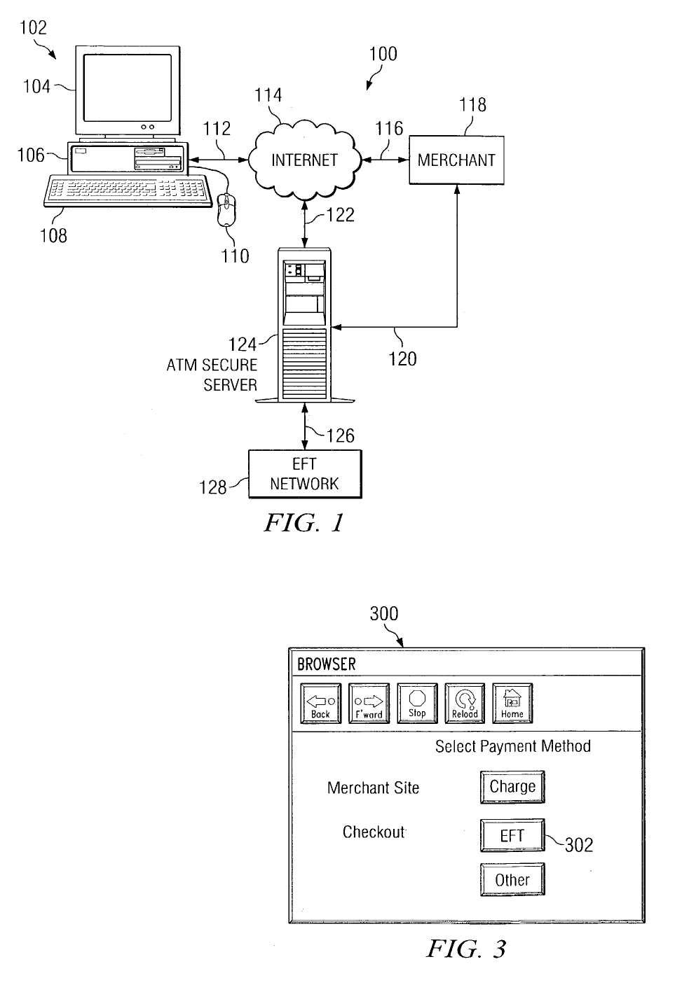

FIG. 1 depicts a simplified schematic of a network-based system for processing transactions 100. A customer operates a terminal 102. Terminal 102 is preferably a standard personal computer (PC), although terminal 102 may be any electronic device with an input, output, processing capacity and memory, including but not limited to a laptop computer, a cellular telephone, a personal digital assistant (PDA).

A customer is defined for these purposes as any user who initiates a transaction. While in the preferred embodiment the customer is an individual making an on-line purchase from a merchant, the term customer should not be construed as limited to a participant in a financial transaction. The customer may be a user in a transaction whose identity needs to be established.

Terminal 102 includes a display 104. In accordance with the preferred embodiment, the display 104 is a standard CRT computer monitor. Other forms of display may be contemplated that provide at least a minimum resolution necessary to provide the output of information necessary to initiate, process and complete the transaction. Terminal 102 includes processing capacity and memory designated in FIG. 1 by computer housing 106. The processing capacity need only be sufficient to perform the processing necessary to the transaction and the memory need only be sufficient to store the data necessary for the processes. Terminal 102 includes an input device, shown here as keyboard 108 and mouse 110. In accordance with the preferred embodiment, terminal 102 includes at least a mouse 110. Other forms of input devices may be used, depending on the terminal type and configurations of the transaction protocols.

In accordance with the preferred embodiment, terminal 102 is communicatively connected 112 to a network 114, such as the Internet. The connection 112 may be any communication medium capable of carrying digital information. The connection 112 may be a dial-up connection to an ISP over a standard telephone line. The connection 112 may be a DSL or cable connection. The connection 112 may be an Ethernet connection, a T1, T2, T3 or T4 line. The connection 112 may be wire, optical fiber or wireless. The connection 112 may be direct or via a local area network (LAN).

Network 114 may be any network including a closed network such as a LAN or a virtual private network (VPN) or an open network such as the Internet. Because of the inherent security risks involved with the use of an open network, the security aspects of the preferred embodiment are specifically adapted for use over an open network. However, those having skill in the art will recognize that the preferred embodiment can be used advantageously with any communication network 114.

Merchant 118 is communicatively connected 116 to the network 114. In accordance with the preferred embodiment, merchant 118 is a server providing web pages designed to offer goods or services for sale over the Internet 114. Merchant 118, however, may be any user who is a participant in a transaction with the customer at terminal 102. The term merchant should not be construed as limited to a participant in a financial transaction. In some cases, the customer's transaction may not involve a merchant 118.

As with communication connection 112, the communication connection 116 may be any medium that can effectively communicate digital data.

Merchant 118 is communicatively connected 120 to an ATM secure server 124. As with communication connections 112 and 116, the communication connection 120 may be any medium that can effectively communication digital data. In accordance with the preferred embodiment, communication connection 120 is a secured, private connection such as a VPN. Because of the nature of the communication between the merchant 118 and the ATM secure server 124, it is preferred that the communication connection 120 be secure from eavesdropping and other forms of malicious intervention and interception. In some cases, communication connection 120 may be coincident with the communication connection 122 between the ATM secure server 124 and network 114.

ATM secure server 124 is represented in FIG. 1 as a server, although the actual configuration of the device or devices that perform the ATM secure server functions may be arranged in a wide variety of software and hardware. As indicated, the ATM secure server 124 is also communicatively connected 122 to the network 114. As with communication connections 112, 116 and 120, the communication connection 122 may be any medium that can effectively communicate digital data.

ATM secure server 124 is communicatively connected 126 to an EFT network 128. As with communication connections 112, 116, 120 and 122, the communication connection 126 may be any medium that can effectively communicate digital data. In accordance with the preferred embodiment, the communication connection 126 is a private secured communication connection.

EFT network 128 communicates with ATM secure server 124 in addition to communicating with ATM machines and financial networks (not shown). The EFT network 128 communicates money transfers, balance inquiries and other financial transactions between customers, merchants and financial institutions. In accordance with the preferred embodiment, EFT network 128 is the standard EFT network in use by existing financial institutions.

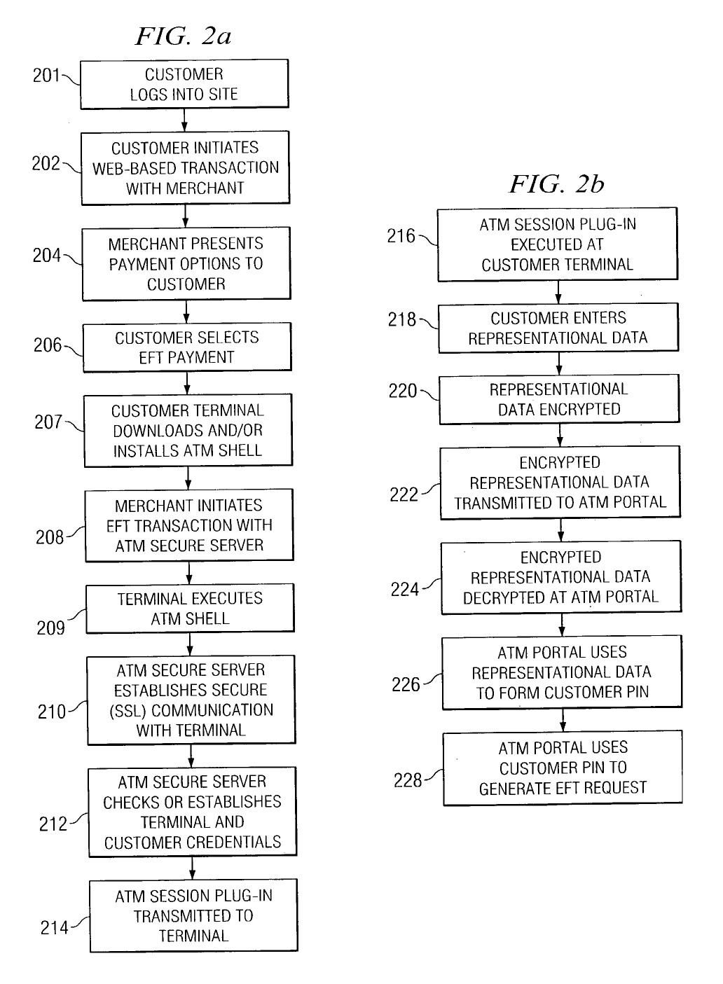

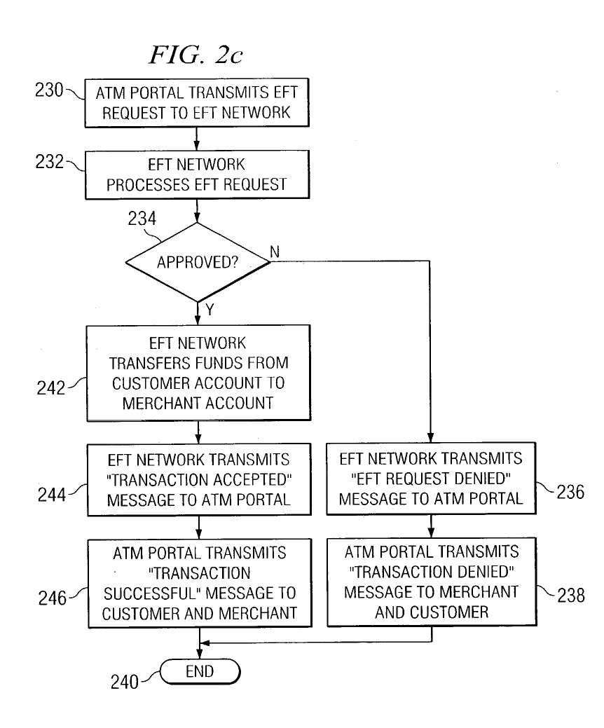

FIGS. 2a-2c depicts the initial steps of a PIN-authenticated transaction in accordance with the preferred embodiment. In step 201, a customer using terminal 102 logs into a merchant web-site. In step 202, the customer using terminal 102 initiates a transaction with merchant 118. In the preferred embodiment, the customer receives one or more web pages via the network 114 from the merchant 118. The transaction may be an order for goods that will be shipped to the customer, reservations, tickets, services, wagers, access to other web pages or virtually any type of transaction requiring the transfer of money from customer to merchant. The transaction may be a customer-to-business transaction, a customer-to-customer transaction, or a business-to-business transaction.

Once the terms of the transaction are established by interactions between the customer and the merchant, the point is reached where the transfer of funds from customer to merchant is required. In step 204, the merchant presents the customer with payment-type options.

FIG. 3 shows a screen-shot of a typical payment option web page 300 as displayed on a computer monitor 104, using browser software such as Microsoft's Internet Explorer. In accordance with the preferred embodiment, the customer is presented with an EFT payment option, which allows the customer to pay for the transaction using an ATM or Debit card. The option is selected by virtually pressing a displayed button 302 by placing a cursor, moved in coordination with the motion of a mouse 110, over the displayed button 302 and pressing a physical button on mouse 110. Other forms of option selection are known in the art and may be used accordingly.

Presented with the payment option web page 300, the customer selects the EFT payment option in step 206. This selection is transmitted from terminal 102 via the Internet 114 to merchant 118.

The terminal 102 downloads and installs a piece of software referred to as the ATM Shell. The ATM Shell may be downloaded from the ATM Secure Server 124, the Merchant 118 or some other site. The terminal 102 may communicate with the ATM Secure Server 124 to assure the terminal's version of the ATM Shell is the most current. The ATM Shell may have been installed at any point of the transaction process prior to the step of executing the ATM Shell.

When merchant 118 receives the customer EFT payment option selection message, the merchant sends a message via secure communication connection 120 to ATM secure server 124 in step 208. The message may communicate the identity of the merchant, the non-authenticated identity of the customer, customer connection information, the amount of the transaction and a transaction identifier. Other information may be included in the message, and in some cases, less information may be necessary. At this stage, the terminal 102 executes the ATM Shell in step 209. It should be noted that the ATM Shell may be executed at any time after it has been downloaded and before the ATM Session Plug-In is executed in step 216.

Using the customer connection information communicated in the message sent by the merchant, the ATM secure server in step 210 initiates a secure socket layer (SSL) session between the ATM secure server and the customer. Other secure communication protocols may be used in place of the SSL protocol. SSL session keys are exchanged in conformance with SSL protocols and all subsequent communications between the customer and ATM secure server are encrypted using the session keys.

In step 212, the ATM secure server requests copies of any digital certificates present on the terminal identifying the terminal or customer from the terminal. The digitally signed certificates can be checked using the public key of the trusted verifier.

In step 214, an ATM session plug-in is transmitted from the ATM secure server to the terminal. The ATM session plug-in is software with a limited-life, dynamically injected, individually usable, trusted software to conduct the authentication procedure of the preferred embodiment.

In step 216, the ATM session plug-in is executed on the terminal 102. The ATM session plug-in may be decompressed or otherwise compiled before execution.

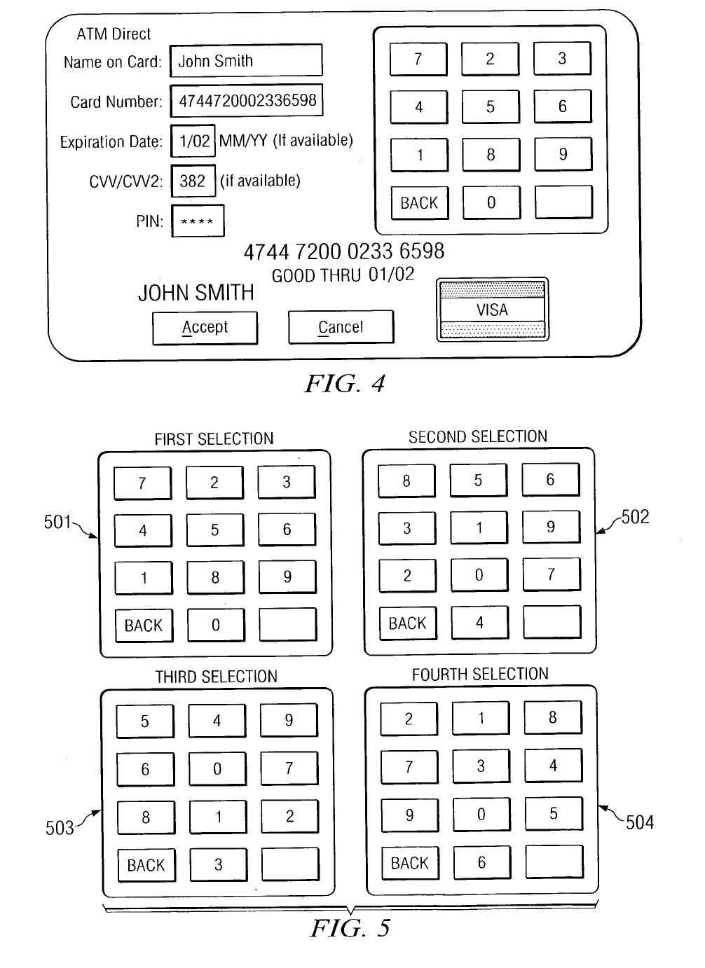

FIG. 4 depicts a typical PIN entry screen as produced by the ATM session plug-in. Using the terminal keyboard 108, the customer fills in the ATM-Debit card identifying information. This information may be collected in the “Name on Card” field, the “Card Number” field, the “Expiration Date” field and the “CVV/CVV2” field.

In accordance with the preferred embodiment of the invention, the customer enters representational data by placing the mouse cursor on the keyboard in representation of the PIN sequence. In accordance with the preferred embodiment, as shown in FIG. 5, the keypad represented on the browser display is randomized as each representation is selected with a click of the mouse button. In this manner, a randomized keypad 501 is displayed on the browser display. The customer moves the mouse to place the cursor over the display of the first number of the customer's PIN. The mouse button is pressed and the ATM session plug-in records the mouse cursor's coordinates. The displayed keypad is again randomized, 502. The customer moves the mouse to place the cursor over the display of the second number of the customer's PIN. The mouse button is pressed and the ATM session plug-in records the mouse's cursor coordinates. This process is repeated 503, 504 until the cursor coordinates of each PIN number selection are recorded.

In step 220, the representational data collected in step 218 is encrypted. The encryption is performed using standard encryption techniques suitable to the security necessary for the transaction. Encryption techniques may include DES, triple DES, AES, RSA, as well as other known encryption methods. In step 222, the encrypted representational data is transmitted from the terminal 102 to the ATM secure server 124 via the network 114. In step 224, the encrypted representational data is decrypted at the ATM secure server. This decryption is preferably performed in a hardware security module (HSM) that is part of the ATM secure server 124.

In step 226, the ATM secure server 124 processes the decrypted representational data to create the customer PIN. In step 228, the ATM secure server 124 generates an EFT request, using the customer PIN in addition to other customer identification data including the ATM/Debit card number. Once the EFT request is generated, the ATM secure server 124 transmits the EFT request to the EFT network 128 via communication channel 126 in step 228. The EFT network 128 processes the EFT request in step 232. The EFT network 128 determines if the transaction has been approved in decision step 234. If the EFT request has been denied, the EFT network 128 transmits an “EFT request denied” message to the ATM secure server 124 in step 236. The ATM secure server 124 sends a “transaction denied” message to the Merchant 118 and the customer terminal 102 in step 238 and the process ends in step 240. If the transaction has been approved in decision step 234, the EFT network 128 authorizes the transfer of funds from the customer bank account to the merchant's bank account in step 242. The transfer of funds is not necessarily done in real time, but may actually occur at any point after the transfer has been authorized. The EFT network 128 then transmits a “transaction accepted” message to the ATM secure server 124 in step 244. The ATM secure server 124 transmits a “transaction successful” message to the merchant 118 and the customer terminal 102 in step 246 and the process ends in step 240.

As shown in FIG. 4, in accordance with the preferred embodiment, the PIN is entered on a randomized graphical interface that creates representational data coincident with the PIN. The representational data is created using shared and/or unshared data between the ATM session plug-in and the ATM secure server. The shared and/or unshared data is unique for each session between a customer and the ATM secure server. The shared and/or unshared data is kept secret and becomes obsolete when the session is completed.

The ATM session plug-in is dynamically distributed to the terminal 102 by the ATM secure server 124 via the network 114.

The terminal 102 is connected by a communication network 114 to the ATM secure server 124. The terminal 102 includes a processor and memory. In operation, the terminal executes an operating system. The operating system defines the terminal's native instruction set architecture or native mode. The operating system is capable of detecting whether a piece of software has an instruction set architecture (ISA) that is the same or different from the terminal's native instruction set architecture, i.e., whether the program can be run in the terminal's native mode. The terminal includes a private translation buffer.

The ATM secure server 124 includes a processor, memory, a database and an HSM.

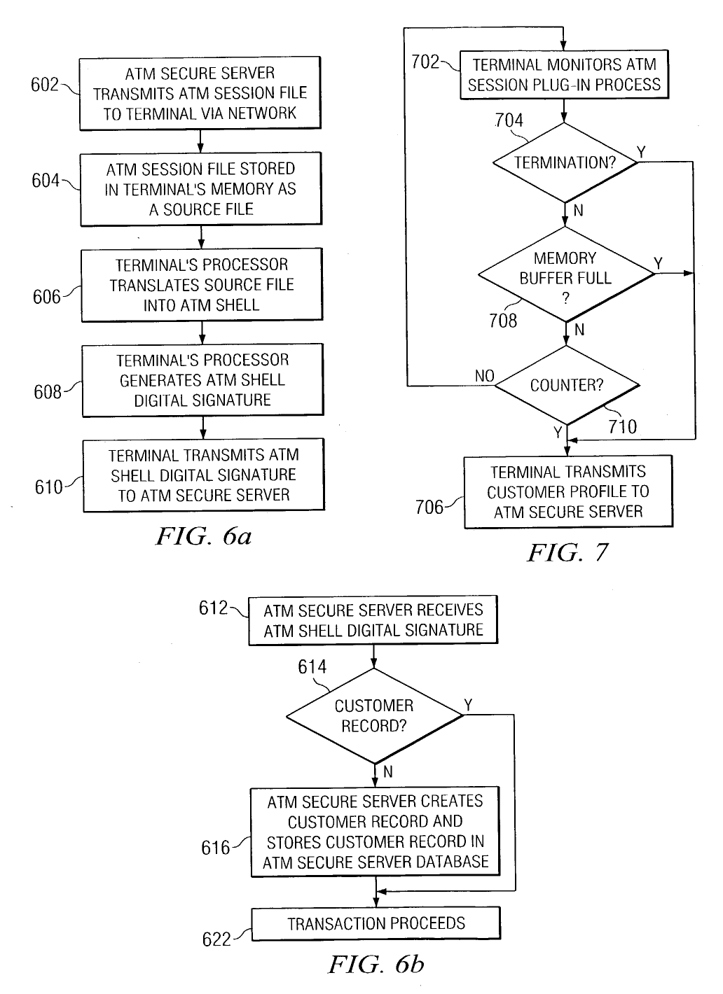

With reference to FIG. 6a, the ATM secure server 124 transmits the ATM session file to the terminal 102 via the communication network 114 in step 602. Upon receipt, the ATM session file is stored in the terminal's memory as a source file in step 604. The terminal's processor translates the ATM session file into an ATM Shell written in the terminal's native instruction set architecture in step 606.

In step 608, the terminal's processor generates a digital signature for the ATM Shell. The terminal 102 transmits the ATM Shell digital signature to the ATM secure server via network 114 in step 610.

With reference to FIG. 6b, upon receipt of the ATM Shell digital signature in step 612, the ATM secure server determines in step 614 whether the customer has an associated customer record registered in the ATM secure server database. If there is no associated customer record in the ATM secure server database, the ATM secure server 124 creates a customer record for that customer in the ATM secure server database in step 616. The transaction proceeds in step 622.

If an associated customer record exists in the ATM secure server database, the transaction proceeds in step 622.

When the ATM Shell is executed it may perform several securing functions. The ATM Shell may generate a digital signature. The ATM Shell may authenticate the terminal. The ATM Shell may unload itself if fraud is detected. The ATM Shell may force an upgrade, downloading a more current version of the ATM Shell from a network connection. The ATM Shell may validate itself by examining data and code segments bound in the file. When authentication and upgrading are completed, the ATM Shell may establish an SSL connection with the ATM Secure Server 124.

Terminal authentication may be created at this point. In the alternative, it may be established in communication with the ATM Secure Server 124. This authentication may require the customer to pre-register the terminal with the ATM Secure Server. Terminal authentication provides the basis for asymmetric key exchange.

FIG. 7 depicts an overseeing function of the process. In accordance with this function, during the transaction process, the terminal 102 periodically transmits customer profile data to the ATM secure server 124. In step 702, the terminal 102 monitors several conditions during the transaction process. When certain conditions are met, the terminal transmits the customer profile data to the ATM secure server. For example, if the ATM Shell terminates in step 704, the terminal transmits the customer profile data to the ATM secure server in step 706. If the terminal's memory buffer is full in step 708, the terminal transmits the customer profile data to the ATM secure server in step 706. If a counter reaches a maximum value in step 710, the terminal transmits the customer profile data to the ATM secure server in step 706.

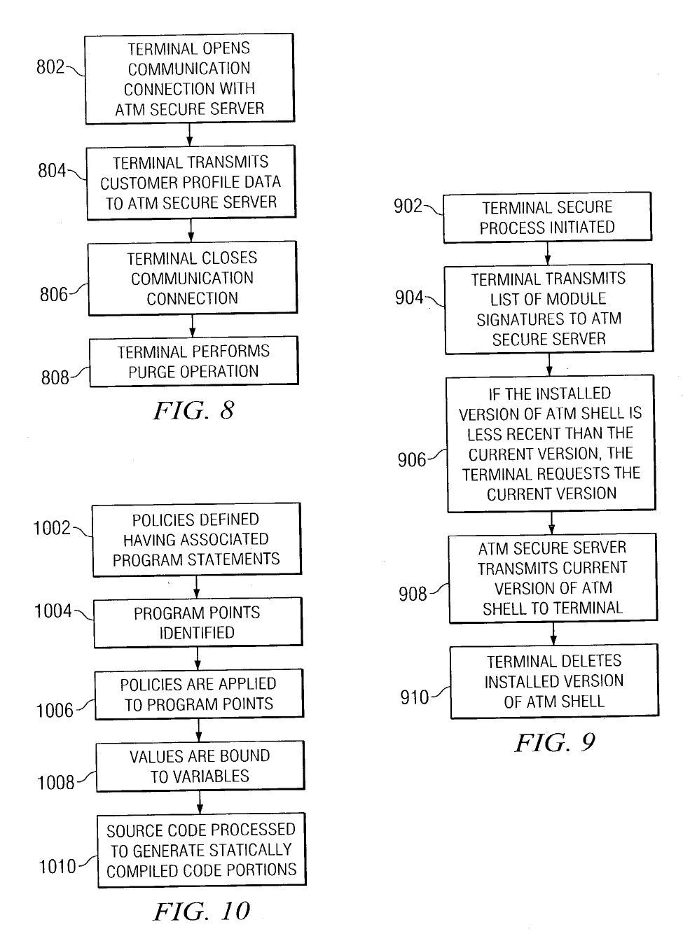

The customer profile data transmission process is depicted in FIG. 8. In order to transmit the customer profile data to the ATM secure server 124, the terminal 102 opens a communication connection with the ATM secure server 124 in step 802. The terminal 102 transmits the customer profile data to the ATM secure server 124 in step 804. After the customer profile data has been successfully transmitted to the ATM secure server 124, the terminal closes the connection in step 806 and performs a purge operation, deleting the ATM session plug-in and any data created thereby from the terminal memory in step 808.

The purge operation deletes all dynamically translated blocks from the terminal memory. The purge operation includes emptying the terminal memory buffer. The purge operation also insures that no residues of the source file, ATM session file or dynamically created data exist in memory or on any fixed media like a hard disk, in a virtual memory cache.

There are a variety of conditions during the transaction process that will cause the terminal 102 to establish a communication connection with the ATM secure server 124. The terminal 102 and ATM secure server 124 establish a secure communication connection when the transaction process is initialized. The terminal 102 establishes a communication connection with the ATM secure server 124 when the ATM Shell loads a corresponding library. The terminal 102 establishes a communication connection with the ATM secure server 124 if the ATM Shell performs a system call. The ATM Shell performs a system call if a predetermined time has elapsed.

FIG. 9a depicts the secure terminal process. When the terminal secure process is initiated in step 902, the terminal 102 transmits a current list of the module signatures of ATM Shell installed at the terminal 102 to the ATM secure server 124 in step 904. If the latest ATM Shell version is higher than the version of the ATM Shell installed at the terminal 102, the terminal 102 requests the current version from the ATM secure server in step 906. The ATM secure server 124 responds by transmitting the newer version of the ATM Shell to the computer at step 908. The terminal 102 then removes installed version of the ATM Shell from the terminal's memory at step 914.

In a network environment, where multiple computers may be using the ATM Shell, the installed version of the ATM Shell is deleted only when none of the computers are using the installed version of the ATM Shell.

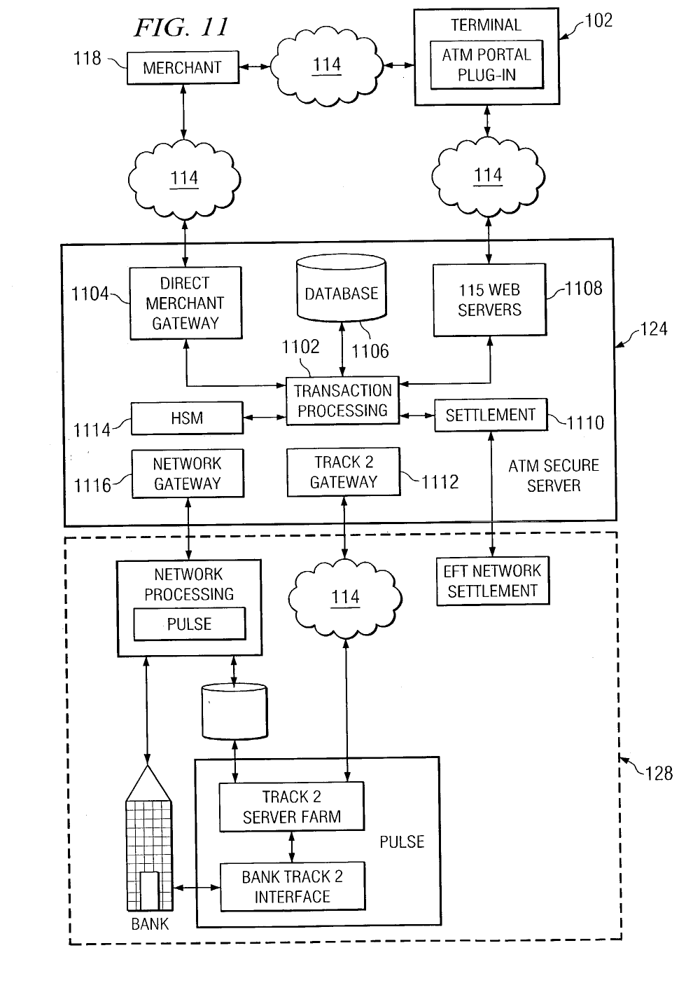

With reference to FIG. 11, the ATM secure server 124 includes a transaction processor 1102. The transaction processor 1102 is connected to an IIS web server 1108 that provides the web-page interfaces to customer terminal 102. The transaction processor 1102 is also connected to a direct merchant gateway 1104 that interfaces with the merchant server 118. The transaction processor 1102 is connected to an ATM secure server database 1106. The transaction processor 1102 is connected to a HSM 1114. The transaction processor 1102 interfaces with the EFT network 128 using a network gateway 1116, a Track 2 gateway 1112 and a settlement gateway 1110.

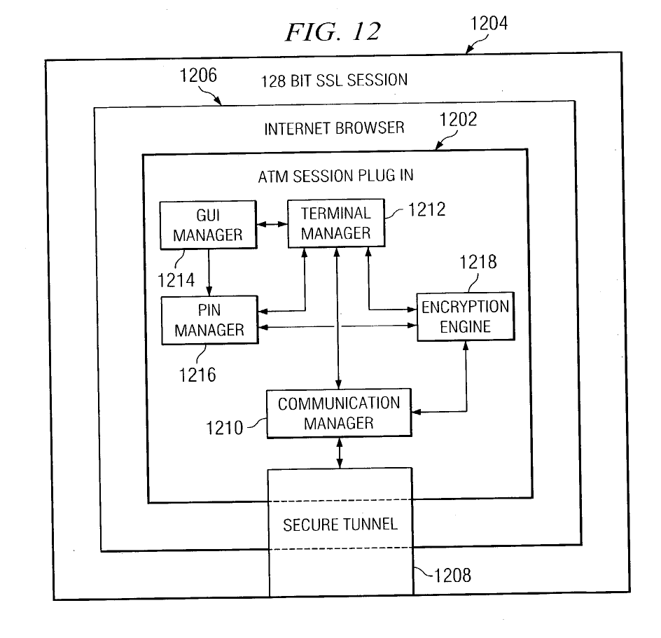

With reference to FIG. 12, a functional diagram of the ATM Shell is shown. The terminal 102 connects to the ATM secure server 124 with a 128-bit SSL session 1204. An Internet browser 1206 is executed on the terminal 102. ATM session plug-in 1202 is downloaded from the ATM secure server 124 and executed. The ATM session plug-in 1202 creates a secure tunnel connection 1208 for secure communication between the ATM session plug-in 1202 and the ATM secure server. A communication manager 1210 within the ATM session plug-in manages the communication processes. The communication manager 1210 receives commands from the terminal manager 1212. The terminal manager 1212 receives data from the GUI manager 1214 and PIN manager 1216. The data is encrypted by encryption engine 1218.

Another embodiment translates a multiple user ATM Shell from a high-level language into a native machine language. By translating the multiple-user ATM Shell into a native machine language, the program can be run on computer hardware in its native mode.

The translation of the source code into the ATM Shell begins by defining at least one source code module. The source code module includes a plurality of code blocks. The code blocks are mapped to the computer memory by the computer's operating system. Each of the code blocks includes one or more source instructions. Each code block begins with one of the source instructions and ending with a branch or a target of the branch. The computer creates a virtual instruction pointer that points to one of the source instructions to be executed. The computer then translates the blocks, beginning with said virtual instruction pointer pointing to said source instruction to be executed. The computer then stores the translated block in a private translation buffer. Finally, the computer creates a shared translation file for the executed block so that the shared translation file is adapted to be accessed by the clients.

The system includes processes for the dynamic modification of source code. The system further includes processes for the dynamic modification of an executable image. The system allows compilation prior to injection into the receiving system, staged compilation, just in time compilation, and deployment for single use code, unique code usable transaction and unique code for use across a plurality of transactions.

The system also allows dynamic modification of executable images to key applications for the single use of executable image. The image may be keyed with specialized data or a plurality of data types, both complex and simple. The data is not limited to specified fields like name and address, but may include encryption keys, random data, and graphical PIN pads.

The executable image keyed to another executable image for a specific system in such a way that the receiving party provides the other portion of an instruction set, code segment, data value, or some combination thereof.

In accordance with the preferred embodiment, the image is polluted with unexecutable data including reference information, such as serial number, checksums, hash values, digital signatures, Message Digests such as SHA-1 or MD5 or the MAC of the message containing the executable image.

The system creates a client-server system that combines static compilation, and dynamic compilation to obtain the advantages of these traditional systems while avoiding their drawbacks.

When a program is written in a source code language different from a native machine code language, executing on a native machine requires either translating the source code into the native machine code or interpreting the source code. The source code language may be high-level, like C, C++ or Pascal, or low-level, level, such as a machine language for a given source instruction set architecture (ISA). A native machine can only execute native machine instructions and such instructions may be semantically or syntactically different from the source ISA. Since computer hardware cannot run source code directly on a native machine containing a native ISA different than the source ISA, various methods are utilized to run the source code on the native machine. Such methods include pure interpretation, static compilation, and dynamic compilation. Each method alone entails certain advantages and disadvantages.

In pure interpretation the source program is never really converted into machine code. An interpreter reads one instruction at a time from the source program, determines what task the instruction should accomplish, carries out the action, and then fetches the next instruction. A problem with pure interpretation, however, is that it runs slowly compared to programs that are written in, or translated to, machine code.

Two methods of translation are a static compilation system (SCS) and a dynamic compilation system (DCS).

The system also provides the ability to discover and translate all the source code in the source file as well as the dynamically generated code. The system collects, analyzes, and periodically submits profile data to enable optimizations that lead to better machine code quality, thus better performance when executing that code. The system also periodically maps new translated code to shared memory so that multiple users can simultaneously execute the code.

Untrusted software supplied by a code producer is verified as safe to execute by a code consumer by defining a safety policy that specifies safe operating conditions of the untrusted software on the code consumer. A safety predicate is generated for the untrusted software. The safety predicate determines if execution by the code consumer of the untrusted software will violate the safety policy. Furthermore, a safety proof is generated that proves that said safety predicate is valid. The untrusted software for execution is validated based on the safety proof and the safety predicate prior to execution of the untrusted software. If the untrusted software was unsuccessfully validated, the untrusted software is deleted from the computer system.

The safety predicate may be added to the untrusted software. The safety predicate is then extracted from the untrusted software to perform the validation. Annotations may also be added to the untrusted software.

The system can in this way verify that untrusted software is safe to execute by using safety proofs to determine if untrusted software is safe to execute.

It is often advantageous for computer operating systems to allow application programs to install code fragments in the operating system kernel. This allows for applications to customize the operation of the kernel without incurring the cost of frequent address space changes and the limitations of a fixed application-kernel interface. However, in such an arrangement, the kernel must be able to determine that the untrusted application code respects the system's internal invariants. Malicious code can disrupt the operating system and can cause unexpected and undesirable consequences.

In distributed and web computing, the task of determining whether untrusted code respects the kernel's internal invariants becomes more difficult when mobile code is allowed. In such a situation, a code producer on one part of the network produces a software component that is transmitted to a code consumer on another node for execution.

High level type-safe programming languages, such as ML and Java, are designed with the assumption that they will be used in a closed environment. A programmer using ML or Java must normally assume that all components of the program are written in that language to establish that the program will have the properties conferred by type safety. However, in practice programs often have some components written in ML or Java and other components written in different languages (e.g. C or assembly language). In such a situation, the guarantees provided by the design of the language are lost unless expensive mechanisms such as sockets and processes are employed. In practical implementation terms, however, it is difficult to determine if the invariants of the ML or Java heap will be respected by untrusted code. Thus, an expensive firewall must be used or the risks of the untrusted code compromising the code consumer system must be accepted.

To inexpensively overcome the risk of untrusted code comprising the system, it is necessary that the code consumer be able to ensure that the code supplied by an untrusted code producer has some previously agreed upon set of properties. Cryptography can be used to ensure that the code was produced by a trusted person or compiler. However, cryptography is weak because of its dependency on personal authority. Even trusted persons, or compilers written by them, can make errors.

Thus, there is a need for a mechanism that allows a code consumer to define a safety policy and then verify that the policy is respected by native-code binaries supplied to it by an untrusted code producer. There is also a need for a mechanism that inexpensively ensures that code from an untrusted code producer is safe to execute by a code consumer.

The process allows the system to verify untrusted software supplied by a code producer is safe to execute by a code consumer. The method includes the step of defining a safety policy that specifies safe operating conditions of the untrusted software on the code consumer. The method also includes the steps of generating a safety predicate for the untrusted software that determines if execution by the code consumer of the untrusted software will violate said safety policy and generating a safety proof that proves that said safety predicate is valid. The method further includes the step of validating the untrusted software for execution based on said safety proof and said safety predicate.

This process represents a substantial advance over prior systems and methods for verifying that untrusted software is safe to execute. The code consumer defines the safety policy, and thus the policy is not limited to a particular notion of “safety.” The process used by the code consumer to determine code safety is automatic and can be implemented by a program that is relatively simple and easy to trust. Thus, the safety-critical infrastructure that the code consumer must rely upon is reduced to a minimum.

The process runs quickly because the code consumer does not modify the code in order to insert costly run-time safety checks. The code consumer also does not perform any other checking once the proof itself has been validated and the code installed.

The code consumer does not need to know the identity of the code producer and does not have to know anything about the process by which the code was produced. All of the information needed for determining the safety of the code is included in the code and its proof.

The process does not require that a particular programming language be used by a computer that incorporates the invention. Instead, the present invention can be used with a wide variety of languages, including machine languages.

As used herein, “code consumer” is a server computer, a server process, a server application, an operating system kernel, or the like which executes trusted or untrusted software, from a code producer.

A “code producer” produces software that is trusted or untrusted from the perspective of the code consumer and which the code producer would like the code consumer to install and execute.

A “proof producer” produces a formal proof for use by the code consumer to determine if the untrusted code is safe to execute. As used herein, the terms “code” and “software” are interchangeable.

It can be understood by those skilled in the art that the present invention may be incorporated into a number of hardware applications. For example, the system may utilize PCMCIA cards, USB devices, firewire devices, a system utilizing “smart” cards, or a system utilizing credit debit, ATM, EMV, or store value cards.

With reference to FIG. 10, the process is initiated by defining policies having associated program statements and values for generating specialized code portions and for integrating the specialized code portions with said statically-compiled code portions in step 1002. Program points are identified where said specialized code portions may be implemented at run time in step 1004. The policies are applied to the program points by entering annotations in the source code in proximity to the program points, using the associated program statements in step 1006. The values are bound to variables in step 1008. The source code is then processed to generate the statically-compiled code portions and to create run-time specializers that dynamically compile the specialized code portions when the specialized code portions are requested to be executed at run-time, based on the values bound to the variables in step 1010.

The source code is made up of variables that may be static or dynamic at run time. The step of identifying the program points is performed with a binding-time analysis based on the policies to identify static variables and dynamic variables at run time.

The process, in accordance with the preferred embodiment, further allows automatically and conditionally specializing source code for a computer program to generate machine-executable instructions. The machine-executable instructions may include statically compiled code portions and specialized code portions. The specialized code portions include dynamically compiled instructions that are generated at run time when the machine-executable instructions are executed by a processor. The program points are then identified in the source code for implementing the specialized code portions. The source code is annotated in proximity to the program points by entering at least one conditional statement at each program point. Each conditional statement may be processed so as to direct the generation of a corresponding specialized code portion based on evaluation of the conditional statement.

The process may include copying a portion of the source code to be specialized and applying a binding-time analysis to the portion. A run-time specializer is created from the copy of the source code portion that was analyzed. The run-time specializer is used to produce a specialized version of the copy at run time. A specializer stub is created that is prepended to the run-time specializer to control execution of said specialized version of the copy at run time.

The process enables on-demand specialization produced across arbitrary control flow edges in a computer program. Source code is processed to generate machine-executable instructions. The machine-executable instructions include statically compiled code portions and specialized code portions. The specialized code portions include dynamically compiled instructions that are generated at run time when the machine instructions are executed by a processor. This process may include generating a specialized source block based on any variables expected to be constant during the run-time execution of said source block.

The system automatically processes a computer program that includes source code to generate machine-executable instructions. The machine-executable instructions include statically compiled code portions and specialized code portions. The specialized code portions include dynamically compiled instructions that are generated at run time when the machine-executable instructions are executed.

When the machine-executable instructions are executed by the processor, the processor binds the associated values to variables. The source code comprises a plurality of procedures. Execution of said machine instructions causes the processor to propagate binding the values to the variables.

The process generates computer code with a dynamic-compilation system that is used to generate executable instructions for selected parts of computer programs for at run time.

Selective dynamic compilation transforms selected parts of computer programs at run time, using information available only at run time to optimize execution of the programs. A compilation strategy is employed during selective dynamic compilation to enable the code-compilation process to be completed in stages—at static compile time, at link time, at load time, and (on demand) at run time. By delaying a portion of the compilation process, it is possible to take advantage of information available only at the later stages, with the goal of improving performance of the resulting code.

Postponing a portion of the compilation process until run time is called selective dynamic compilation and should not be confused with complete dynamic compilation, where all program compilation is done at run time. (Recently introduced “just in time” compilers for JAVA are examples of complete dynamic compilers.) As used in this specification and in the claims that follow, the term “dynamic compilation” refers to selective dynamic compilation and not to complete dynamic compilation.

Value-specific selective dynamic compilers derive their benefits by optimizing parts of programs for particular run-time computed values of invariant variables and data structures (called run-time constants), in effect, performing a kind of dynamic constant propagation and folding. Programs and program portions that are suitable for selective dynamic compilation include: (a) highly parameterized computations that use a significant amount of time consulting parameters, but often run using the same parameter settings; (b) programs with many similar subcomputations; (c) programs of highly interpretive nature, e.g., circuit and other simulators, where specializations remove the time to scan the object being simulated; and (d) database query search algorithm. Additional proposed applications for selective, value-specific dynamic compilation include specializing architectural simulators for the configuration being simulated, language interpreters for the program being interpreted, rendering engines for scene-specific state variables, numeric programs for dimensions and values of frequently used arrays, and critical paths in operating systems for the type of data being processed and the current state of the system. Trends in software engineering that are moving toward dynamic reconfigurability, such as parameterization for reuse and portability across different hardware architectures, also imply a promising role for dynamic compilation.

The principle challenge and trade-off in selective dynamic compilation is achieving high-quality dynamically generated code at low run-time cost, since the time to perform run-time compilation and optimization must be recovered before any benefit from dynamic compilation can be obtained. Consequently, a key design issue in developing an effective dynamic-compilation system is the method for determining where, when, and on what run time state to apply dynamic compilation.

The system includes a memory in which a plurality of machine instructions including a compiler are stored, and the memory is coupled to a processor that executes the machine instructions to perform the steps of the foregoing methods. The machine instructions preferably instruct the processor to create run-time specializers by generating extensions that dynamically compile the specialized code portions when the code portions are requested to be executed at run time, based on the annotated policies and/or conditional statements in a program's source code.

The generating extensions allow the program to be distributed as a stand-alone application. One result of run-time specialization can be that many specialized versions of a single portion of code are produced. Specialization can be used to perform complete processing of a nested algorithm, which results in the creation of a plurality of run-time generated code segments that collectively occupy much more space than the code in the original implementation. If the run-time generated code is larger than the instruction cache on modern microprocessor architecture, the program's performance will likely be degraded. Conditional specialization can be used to avoid such performance degradation by testing whether the amount of code that is estimated to be generated is larger than the instruction-cache size (or at least large enough to produce significant conflicts with other code). If the number of iterations of a loop that could be completely unrolled in advance is known a priori, then a test such as the following could be used.

Dynamic compilation overhead is measured as cycles per dynamically generated instruction; also included is the number of instructions generated to place the instruction-specific overhead in context.

Whole-program speedup due to dynamic compilation depends on the proportion of total run time that is spent executing the dynamic region.

The machine instructions comprising the software program that causes the CPU to implement the functions of the present invention that have been discussed above will likely be distributed on floppy disks, CD-ROMs, communication protocol, network interfaces, applications, or other memory media and stored in the hard drive until loaded into random access memory (RAM) for execution by the CPU.

In accordance with the preferred embodiment, the process uses a HASH on financial transactions to insure key information such as receipt numbers, transaction numbers, amounts have not been tampered with prior to delivery to the customer, by the customer or by some 3^{rd} party. The preferred embodiment is designed to eliminate receipt fraud for online and offline merchants and merchant processors and associated financial transactions.

The system uses a public or private network to establish a secure closed network with Merchants and Merchant processors to insure that all transactions performed over open networks on behalf of said merchant can be verified and authenticated in real time. The resolution of transaction, either approved or denied, can be delivered to said merchant or merchant processor in real-time to eliminate transaction fraud originating from non-participating merchants and replay of previously successful transactions on-behalf of a in-network merchant or merchant processor.

The system and method allows for the secure entry of data on a client computer for transmission over the Internet to a destination server without the information ever being transferred or coming into the clear. One aspect of this relates to secure PIN management on the Internet. Representational data constructed using a bank-assigned or customer-selected PIN number on a computer, mobile device, or mobile phone (card acceptor device) is entered in such a way that the PIN never registers in the device. The device creates the representational data using a dynamic injection of code, keys and totally random algorithms into the client. This allows information other than the PIN to be transferred over the Internet to the secure data center for processing by a uniquely modified FIPS compliant HSM that meets TRSM requirements as stipulated by the X9 Banking standards. Then the uniquely modified FIPS compliant device, in a secure environment can assemble the unrelated transferred data, plus the unshared secret on the server side to assemble the PIN, without ever having the PIN register anywhere on the computer or without ever passing the PIN over the Internet.

The system may also be used for the open distribution of electronic money. The system includes a tamper proof customer client. A tamper proof server in a secure data center is associated with the tamper proof customer client. The tamper proof server securely communicates with the tamper proof customer client. The tamper proof server in the secure data center is connected to an authorization network and initiates the authorization process and assembles the PIN.

The account credential may be an ATM or debit card PIN number. The customer client provides purchase information to a merchant. The purchase information doesn't need to be trusted. Secure PIN information is transmitted from the tamper proof customer client directly to a trusted agent without the merchant having access to the PIN.

The customer downloads software and does not use a device outside of the computer or mobile phone itself. The customer enters his account credential. The account credential is the customer's ATM or debit card PIN. In accordance with the preferred embodiment, the PIN is entered with a mouse and graphic display of a scrambled keypad. By using this method of PIN entry, the keyboard is not used. This method of entering the PIN prevents anyone from electronically reading the PIN. The PIN is not registered or stored anywhere on the computer including the computer memory.

The software creates an unshared secret on the customer terminal. The code, keys and random algorithm are delivered dynamically and have a limited life in both time period of existence and they are only good for this one transaction. All transactions between the server and client are one way ciphers. Random images on the computer, not being the PIN, are converted into representational data that cannot be read without the unshared secret remaining on the server. The information that is stored and transferred is not an encrypted form of the PIN. The representational data constitutes a random message that is numerically unrelated to the PIN.

The representational data assembled by the client computer is digitally signed and digitally enveloped, and transferred over the Internet. The message enters the secure data center and enters a programmable HSM device capable of reading intelligent programming. The PIN is assembled in the modified HSM using random number generation. Because the PIN is assembled in a secure hardware environment that meets current FIPS and banking requirements, the PIN can now be transferred through a closed circuit directly to the EFT infrastructure as all ATM and Debit transactions currently occur.

The system provides a secure system using a trusted client and trusted server to deliver information that can be assembled as a PIN on the server side, not client side which in turn authorizes the distribution of electronic money from financial institutions and payment authorization networks to Merchants.

The preferred embodiment allows use with personal computers for Internet transactions but the system can be adapted for use in POS brick and mortar transactions as well.

One advantage of this system is that no additional hardware is needed to allow a standard home computer to perform the transactions. This system provides an all-software solution.

The PIN is entered in the consumer's computer it is never registered anywhere in the computer or in the memory of the computer, or on the keyboard. The data that is entered into the computer is not the PIN nor is it an encrypted form of the PIN. Without the secret that is hidden on the server side, the PIN cannot be determined. This moves the process of PIN assemblage to the server-side, not the client side and turns any device into a “card acceptor” and a secure PIN-entry device. As the PIN is never transferred over the Internet, security is not an issue and the method of transport does not depend on encryption.

In accordance with the preferred embodiment, there is provided a coded identification system that in this case is the bank-assigned PIN number on both ATM and Debit cards presently in existence. The system includes an electronic computer, wireless hand-held computer or mobile phone that is the client device, and the server located in the ATM Secure server and is connected directly to all EFT networks in the world.

The client first downloads the ATM Shell as the client is connected to the Internet. When the first transaction occurs, the server side code is generated on demand and the code in unique for every transaction. It is dynamically delivered to the client and there is a signed and secure delivery process. The code delivered to the client has a limited life of a split-second for the code, key and algorithms. The software creates two unshared secrets on both the server and the client and all communications is in one-way transactions.

The PIN is entered using the secure ATM Shell interface on the browser using a mouse and graphically displayed scrambled keypad. The use of the mouse and graphic keypad prevents ghosting. No PIN is ever transmitted and no PIN ever appears in the memory of the computer. This method of transfer is not dependent on encryption. Using images and a random algorithms an incomplete message is formed, which is not the PIN, and can never be discerned to be the PIN as long as it is in the computer or passing over the Internet, because of the unshared secret remaining on the server, until the message enters a modified secure HSM device in the data center which can read intelligent data and assemble the PIN in a secure device and environment.

As a message for transporting data between a client computer and a secure server with hardware encryption, the PIN can never be transported in the clear. No matter what level of encryption, the system and method are still dependent on data which is open to attach on the client machine or over the Internet, and it is physically possible to attack a PIN which has been encrypted. In the disclosed method for transporting data, the PIN is never in the clear, never in the memory of the computer, and never sent over the Internet. The PIN is instantaneously converted to data using a random algorithm and is always incomplete because both the server and client of unshared secrets. The PIN is never assembled until the data is in a TRSM. A secure HSM device in a secure data center. This is the only method that can guarantee the integrity of the information, that the message content was not open to attack on the client machine, altered during transmission between the originator and the recipient, and that the PIN is never in the clear subject to attack.

The system provides an all-software PIN-based Internet debit payment solution. It enables online shoppers to pay and merchants to accept cash for purchases with their debit/ATM cards and for the first time on the Internet. Our core technology allows any person with an ATM or debit card to safely use their bank-bank-assigned PIN number on the Internet. It requires no add-on hardware like a swipe device and no change of habit for the consumer. The customer selects to pay in cash using their ATM or debit card and downloads the ATM Shell that secures their computer as a payment terminal. The customer than simply inputs their bank-assigned PIN number and the transaction is processed using the debit networks, not the credit card networks.

The ATM Secure Server 124 enables all communications to occur between only the customer and the financial institution, excluding the merchant 118 and all other parties from the transaction to protect the integrity of the transaction. The transactions conducted with the PIN are non-reputable.

The use of downloadable executable software is a standard feature of browsers enabled with JAVA support and all versions Microsoft's IE (“Internet Explorer”). The implementation of the two environments take on significantly different runtime characteristics, JAVA utilizes applets, which run within a JVM, a process that is not native to windows. While IE support's the downloading of platform specific code, compiled into DLL's that expose COM/ActiveX interfaces, allowing the downloaded software to execute as a native extension to the operating system.

An apparatus, method and system are disclosed for providing network security for executable code in computer and communications networks, such as providing network security for downloadable and executable native application that was generated from such programming languages such as assembly, “C” and “C++”, or bytecode compatible languages utilizing a runtime services of the operating systems, such as Visual Basic or previously installed runtime environments such as a JVM/JRE as required for JAVA support.

The embodiment includes a network interface for the reception and transmission of data, DLL code or applications. The transmission and/or reception may be triggered by keywords in a script, web page, file, memory location that instructs one or more applications, code segments to begin executing the workflow and/or process steps that support the triggering event, an example is the OBJECT ID tag statement commonly found in HTML code.

Such invocation of such and includes a processor having program instructions to determine whether network information includes a language keyword, such as a “OBJECT ID” tag statement in the HTML of the active web page, and sub-references within that tag statement, such as (1) “CLASS ID” of the OBJECT, (2) “CODEBASE” which defines the location to source the “OBJECT” in this case the executable and/or the CAB file containing the executable.

When the network information includes such a network language keyword, the processor includes further instructions is further responsive to generate the network language keyword having a distinctive reference to corresponding executable code, such as a distinctive OBJECT ID and/or CLASS ID and/or CODEBASE, and to provide, for transmission by the network interface, the network information in which the network language keyword incorporates the distinctive reference.

When the network language keyword incorporating the distinctive reference is invoked, the processor includes further instructions to provide, for downloading by the network interface, the corresponding executable code or activation if said executable code already exists on the system.

The network server will evaluate the request and based on data collected during activation from the client system to determine what activity to perform or instruct said client to perform on it's request, (1) allow activation, (2) new system allow download of executable code, (3) remove existing executable code and deny request, (4) replace existing executable code.

The network server will not allow more than one instance of executable code to exist on a target system.

The network server will request from other processes a unique package that conforms to; standard activation policies of the Microsoft IE Browser; standard activation policies of the Microsoft Operating system; standard activation policies of any 3^{rd} party system required to activate said executable image.

Furthermore, the following steps may be required to insure that the process is secure, additionally one or all of the following steps in or out of order as stated may be required;

digitally signed to the target machine,

digitally signed with a signing certificate issued by Verisign or other signing authorities that have root certificates installed in the browser/or in the root certificate store provided by the operating system provider, or a root certificate store provided by a third party,

package and or contents are keyed to run only on the target system,

content keyed with unique keys

keyed with unique data that may or may not be dependant on subsequent transmissions and either to or from the network server,

unique algorithms partially or completely

evaluation of target rules based on static and dynamic evaluation that may generate incomplete code segments that will be required to be patched at runtime to insure application can only operate when connected to the target system,

custom crafted interfaces and algorithms that insure Dynamically Injected executable code is trusted and will operate deterministically within the context of the executable code

registered to the database and processing systems,

enveloped into a unique CAB file that undergoes compression to minimize upload timelines,

code sent natively

code signed with signing certificate

CAB file signed with signing certificate

verification all communication is operating under SSL

verification that SSL versions are the highest offered and supported

verification that SSL version is secure

use of a private network wherein SSL or other forms of secure communication is not required

verification of client IP address

verification of server IP address

verify no DNS redirection is occurring

verify target system is in authorized boundary, country, state, or other geographical region definition

verify that the ISP in use is not unknown,

verify that there are no black holes in the route path of the transaction

signing of some or all data, code and applications to attest to any system having the capability to verify authenticity of the signer and as such is being distributed by the ATM Secure Server

conforms to browser activation requirements, including but not limited to Microsoft's IE products

executable code may take the form of DLL's, ActiveX controls, scripts, COM, COM+, JAVA and any native or interpretive code that is supported under Web Services.

The system may also implement opaque behavior, where the download process is not visible to the Microsoft IE browser.

The system allows the delivery of software particularly for a single-use. The software may be unique, so that every delivery provides individualized software to the terminal 102, unique for every transaction. The software may have a limited lifetime, so that the software is only function for a specific period or specific block of time. The software may have limited visibility, such that the software cannot be easily viewed or modified. The software may be keyed to the target system, such that the software will only function properly on a particular terminal. The software may be signed, encrypted and compressed for delivery and security purposes. The software may be platform and executable image specific.

The network server having received a request from the target system to deliver this executable image may;

request creation of the executable image, script or data,

customize the executable image to insure that only the target system can utilize the image

perform a HASH on the image and insert in a location in the image or in subsequent conversations to insure image being transmitted has not been tampered

pollute or change aspects of the executable image to make the executable image unusable by the target system

provide a methodology to enable un-pollution of a polluted image

perform a HASH on the polluted image and insert in a location in the image or in subsequent conversations to insure image being transmitted has not been tampered

encrypt the image using a symmetric key exchanged between systems

encrypt the image using PKI

utilize one or more methods of encryption, which may include DES, Triple-DES, AES, PUBLIC/PRIVATE KEY cryptography,

provide protection of encryption keys by use of a KEY exchange, a master KEY session, a KEK, a PUBLIC Key exchange, unique keys per session, DUKPT or other conventions that protect the transmission

utilize a private network via a direct dialup, x.25 frame circuit, physical VPN, software VPN, or other methodology to secure the communication between systems

utilize the internet accessed via a public or private network connection

MAC the message or messages exchanged,

HASH messages,

Load executable image into the process memory of the application to insurer process that will be activated is not visible in the operating system

The integrity checking of the executable image varies between embodiments; the target systems browser will automatically handle the downloading, unpacking and installation of the controls found in the CAB package.

Our methodology extends that current work of art to incorporate full life cycle management of the process to insure the target system is always, (1) in a deterministic state, (2) registered code has not been altered, (3) system has not been altered for purpose of fraud, (4) updates to the executable image occur when required not automatically.

The integrity checking of the second embodiment will be performed, (1) the host will verify the HASH of the in-process executable image, (2) the host will decrypt the executable image, (3) the host will modify the executable image using the rules and data incorporated into the hosts executable image at creation and as specified in subsequent exchanges with the network server, (4) host will calculate the HASH for the decrypted, un-polluted image and verify it against the HASH appended to the image, (5) insure time-limits have not been exceeded, (6) activate the image, (7) wipe memory by over writing the dynamically allocated memory area with randomized data, several times to insure virtual memory (“cached to disk”) can not be used to restore the operational image.

Furthermore the in-process executable image once activated will, (1) perform integrity checks to insure no tampering has occurred, (2) connect to the network using a separate SSL v3.0 TL1 session to envelope the conversations from the activating executable image if required, (3) perform it's in-process work, including acquiring data, generating graphical interfaces such as PIN Pads, accepting keyboard and mouse signals, executing algorithms and maintain secure communications with the network server, (4) insure code image time-limit has not been exceeded, (5) wipe memory as needed and upon completion.

In the event that the system detects faults or the requirements for activation are not met for either embodiment, the existing installation may be removed, auto-update will be denied, the user will be informed of the issues and corrective actions that might be acceptable to correct the risk evaluation.

The system provides network security for executable code. The system includes a network interface coupled to a network communications channel for the reception and transmission of network information.

A processor is coupled to the network interface. The processor responds through a set of program instructions to determine whether the network information includes a first network language keyword. When the network information includes the first network language keyword, the processor further responds to generate a first distinctive reference to a first corresponding executable code. The processor transmits by the network interface the network information in which the first network language keyword incorporates the first distinctive reference. When the first network language keyword incorporating the first distinctive reference is invoked, the processor further responds by transmitting the first corresponding executable code. A memory coupled to the processor stores the first corresponding executable code.

The system wherein the processor is further responsive, when the network information has a plurality of network language keywords, to generate a plurality of respective, distinctive references to a corresponding executable code; to provide, for transmission by the network interface, the network information in which each network language keyword of the plurality of network language keywords incorporates a respective, distinctive reference; and the processor further responsive, when a network language keyword incorporating a respective, distinctive reference is invoked, to provide, for transmission by the network interface, the corresponding executable code.

The system generates multiple network language keywords. Each plurality of the network language keywords corresponds to a separate request for network information. Each network language keyword includes a respective, distinctive reference to a corresponding executable code.

The requested network information may be a World Wide Web page. The first network language keyword may be an ActiveX tag, herein referred to as a OBJECT ID tag, wherein the first distinctive reference is the OBJECT ID and/or CLASS name and or CLASS id, and wherein the first corresponding executable code is any CAB file containing a valid DLL with a valid COM/ActiveX interface. The presumption is that all bytecode, endian and alignment issues will be address by either the operating system or the network server.

The system may be embodied with a server, or client, or device attached to either a client or server, or a device required to be attached to both client and server. The system is configured so that a network language keyword may be an object tag, an HTML keyword, a scripting language keyword, or an instruction.

The system wherein the processor further executes instructions to randomly generates the first or successive distinctive reference or references.

The system's processor may execute instructions to select the first distinctive reference from a set of predetermined distinctive references.

A method of providing dynamic class naming for DLL's, COM and COM+ interfaces, Web Services, ActiveX controls and successive interfaces, the method comprising:

receiving a request for a web page, or

determining whether the web page includes a first OBJECT ID tag, or

invocation of target executable image

An example of a HTML OBJECT ID tag;

<OBJECT ID=“MYPOPUP” CLASSID=“CLSID:B60FDF68-5635-49BE-95F3-0F2324E7C87E” CODEBASE=“http://192.168.1.103/MYDIRECTCTRL.CAB#version=−1,−1,−1,−1”>

The system and processes of the preferred embodiment are designed to manage identification data such as a Personal Identification Number (PIN) in a manner that will be accepted by a financial network, such as EFT. For existing financial networks, this means that the system and processes must comply with the regulatory requirements set forth by the X9 committee. These include associated audit requirements set forth by X9 committee as embodied in the X9-TG3 and as it refers and pertains to X9 standards, such as X9.8, X9.24 and other related standards and best practices.

The preferred embodiment uses a programmed Hardware Security Module (HSM) 1114 to perform secure PIN processing for bank issued Debit and Automated Teller Machine (ATM) Cards. The HSM 1114 is securely connected to the ATM secure server 124. The HSM 1114 and ATM secure server 124 are maintained in accordance with security standards that address both connective security and physical security. The ATM secure server 124 is connected to a network 114. The network may be a closed network, such as a VPN, or an open network, such as the Internet.

A terminal 102 under the control of a customer captures the customer's PIN. In accordance with the preferred embodiment, the PIN itself is not captured, but instead representational data corresponding to the customer's PIN is collected. This representational data may be referred to as PIN data. In accordance with the preferred embodiment, the terminal 102 is a general-purpose computer executing software that enables the prescribed functions. The terminal 102 is connected to the ATM secure server 124 via the network 114, which may be a closed network or an open network like the Internet. In the preferred embodiment, the terminal is connected to the ATM secure server via the Internet using a 128-bit SSL session 1204.

In accordance with the X9 standards, authentication data such as a customer PIN used in a financial transaction can not be protected solely by conventional cryptography. In accordance with the preferred embodiment, a layer of security is added by generating representational information corresponding to the customer PIN. The customer PIN is never collected, stored or recreatable at the terminal 102. The representational data is generated using (n) unshared client secrets that have been provided by the ATM session plug-in 1202. This representational data is then encoded and transmitted to the ATM secure server 124.

Upon receipt of the encoded representational data, the HSM 1114 decrypts the encoded representational data to generate the representational data. The HSM 1114 uses the representational data to generate the customer PIN. The (n) unshared client secrets generated by the client and used to create the representational data are regenerated using (n) unshared server secrets maintained and generated by the ATM secure server 124. Using the regenerated (n) unshared client secrets and the representational data, the customer PIN is generated.

This same method can be used to transfer knowledge of any form of secret or sensitive data.

When the customer PIN has been generated, the HSM 1114 encrypts the customer PIN data into a PIN Block. The PIN Block is used to authenticate a financial transaction. The PIN Block is created using a PIN key injected into the HSM 1114. The PIN key is protected with a key-encryption key (KEK). This process, involving both the keys and PIN processing, are preferably done in a manner that conform to the X9 standards.

The HSM 1114 may be used to perform secure translation of signals from remote terminal. The HSM 1114 communicates with the remote terminal 102 over the network 114. In accordance with the present embodiment, signals are acquired and accepted by the ATM secure server within a secure facility. The HSM 1114 decodes the encoded signals received from the terminal 102 to generate representational data corresponding to a customer PIN. The representational data could, in alternative embodiments correspond to a social security number, or other sensitive or secret data.

This embodiment is particularly useful in cases where conventional encryption of the information data is not sufficiently secure to be relied upon as a manner of secure delivery. The HSM 1114 may be enabled to intelligently interact with the ATM secure server 124 in a secure manner. The interaction is performed using unique code, algorithms, and keys, herein referred to as processing data, for the acquisition of the signals. The HSM 1114 solves for the (n) unshared client secrets that were generated on the client, using the (n) unshared server secrets generated on the ATM secure server. Other discretionary data may be required to translate the signals from representational data into a customer PIN.

The interaction between the HSM 1114 and the ATM secure server 124 may occur via a SCSI interface, a PCI interface or network interface. An interface is not preferential but may be constrained by methodology requirements necessary to enable the HOST to send and receive data as well as coding to and from the HSM so that the methodology meets or exceeds the X9 security standards.

A Secure Configuration Terminal (SCT) may be enabled to provide the HSM the keys in a manner that conforms with the X9 key management standards

In a fifth embodiment secure forms of financial transactions, authentication and privacy are enabled. By securing traditional data orientated transactions to the level equal or exceeding those currently in place with PIN based Debit and ATM transactions, commonly referred to as Online DEBIT, the present embodiment provides the secure framework and method to realize the objectives of the following initiatives; European Union 1995 Data Protection Directive, the U.S. 1996, Federal Healthcare Insurance Portability and Accountability Act (HIPAA), MasterCard International and Visa International 1997 Secure Electronic Transaction (SET), MasterCard International SPA initiative, Visa 3D and Verified by Visa initiatives, the 1998 Identrus LLC security authentication framework specification, and the U.S. 2000 Federal Electronic Signature Act (E-Sign).

A programmable HSM may also referred to as an intelligent HSM. A programmable HSM is, generally, any HSM that can interpret data as programmatic instructions. Programmatic instructions may refer to executable images like an assembly, C or C++ application or runtime images like a JAVA application. By programming the programmable HSM, the programmable HSM may implement new behavior either statically or dynamically. The programmable HSM can be programmed with the capability to securely interact with the cryptography functions of the HSM. In accordance with the preferred embodiment, applications can be downloaded into the HSM via a secure methodology. The applications may be input to the HSM via a serial port, network adapter, smart cards, floppy disk, CD-ROM, infrared port, or other known input means. The executable code is made into trusted executable code with a digital signature of the executable code generated by an authorized publisher. The executable image, when executed, is programmed to exchange data with connected systems securely. The resulting communication does not compromise the HSM or the keys stored. In accordance with the preferred embodiment, the HSM supports smart cards that can be read and written.

Furthermore said HSM is a Tamper Resistant Security Module (TRSM) and with software components, customized SCT, ACL definitions, policies and procedures a programmable HSM can be made to meet the X9 Key management requirements, including but not limited to;

Establishment and management of a KEK

Split knowledge

dual control

key fragments

key pair generation

key injection

key combining

key exchange

key loading

key recovery

destruction of keying material

keys not in the clear

pin block creation

pin block translation

pin not in the clear

tamper proof enclosure

key destruction when enclosure or HSM has been breached

policies and procedures are auditable and verifiable

The HSM is encased in a durable, tamper-resistant casing to protect the system against incursion, with built-in detection features can sense sophisticated attempts at physical or electronic tampering. Any unauthorized attempt to access the security module results in the immediate and automatic erasure of the secret data stored in the HSM, more specifically the HSM qualities that separate it from other devices are;

TRSM (“tamper-resistant security module”) enforcing key confidentiality and separation, dual control, and, potentially, tamper detection and active countermeasures (e.g., automatic key erasure). Such devices and environmental security controls exist at most financial institutions and network processing centers, and at many military installations. The use of Access Control Lists within a HSM that is also a TRSM allows very fine-grained control over key separation, key injection, and key management. The HSM can only accept trusted code from a trusted publisher, wherein said code may be digitally signed by the publisher. The HSM can be configured to refuse loading trusted code during key loading. The HSM can be configured to restrict code loading to meet X9 audit approval. The HSM has preferably passed FIPS-140 validation. The HSM in conjunction with a SCT and approved key management practices allows for management of keys for injection into devices that are geographically separate as is required for business continuance best practices. The HSM in conjunction with a SCT can be designed to meet or exceed all key management practices as required by the X9 TG-3 audit guidelines and associated standards. The HSM can be designed to meet the X9 requirements, those standards require that private keys (and symmetric keys) should only exist in the following secure formats:

As cleartext inside the protected memory of a tamper resistant security module

As ciphertext outside the protected memory of a tamper resistant security module

As two or more key fragments (e.g., key components, k-of-n key shares), either in cleartext or ciphertext, managed using dual control with split knowledge-fragmentation of keys: secret-sharing enables key fragments to be stored separately on tokens so that ‘k of n’ key fragments are required in order to load or reconstitute the key being protected good security practice should ensure that there is ‘key separation’. This is the security method whereby each key (or key pair) is generated for a particular purpose and is used for the sole purpose for which it was intended. The SCT may be interfaced directly or indirectly to the HSM for loading the KEK, key pairs, or other activity that must meet the X9 standards for Key Management and best practices. The SCT can be connected directly to the HSM via one of several choices, SCSI, IDE, Serial port, Parallel port, USB port, keyboard, mouse, infra-red, firewire port, or connected indirectly to the HSM utilizing one or more options such as infrared. The SCT may be interoperable with the HSM via use of smart cards with supporting process and procedures to insure key management policies and procedures can be implemented that meet or exceed those required by the X9 key management standards or that is acceptable to a X9 accredited auditor, or other direct or indirect connection methodology not yet discovered or identified in this art that support said standards directly or indirectly by adoption of process and procedures to insure said methodology is acceptable to a X9 accredited auditor.

The SCT will be encased in a durable, tamper-resistant casing to safeguard the system against incursion, and will provide built-in detection features can sense sophisticated attempts at physical or electronic tampering. Any unauthorized attempt to access the security module results in the immediate and automatic erasure of the secret data stored in the chip.

The SCT will provide an optional graphics display that supports a variety of graphic character sets, including those used in Japanese, Chinese, Arabic and Cyrillic-based languages. The display may be configured to show two lines of Chinese prompts, two lines of large characters or up to four lines of roman text, and may be capable of displaying two languages simultaneously, such as French and English, for use in multilingual markets.

The SCT may support custom application development and remote downloading of an executable image. The download process may or may not support a trusted producer, wherein said download code is signed with a digital certificate, hashed, MAC or other methodology to identify to the SCT that the code is trusted.

The SCT may provide access control via use of smart cards, token devices, password, or other methodology to insure that;

downloading of code can only be accomplished by authorized trusted entities,

use of the devices is restricted,

key loading with device is restricted to authorized parties,

key injection with device is restricted to authorized parties,

downloading of software to the device utilizes a proprietary protocol, and

downloading of software can be restricted.

The SCT can insure that access to any keying information entered can not be controlled including denied to one or all users of the SCT.

The SCT can provide one or all of these features;

Host interface

simultaneous support for multiple key management functions

comprehensive software security and tamper-proof casing

Keys stored in securely in security chip and the ability to wipe keys from the security chip upon completion of keying activity if required.

Communications between keyboard, display and security module safeguarded

PIN PAD that supports alpha-numeric entry

Smart card reader and writer supporting a plurality of asynchronous and synchronous memory and protected-memory cards

Magnetic Stripe reader that can read and write Track 1 and 2 or Track 2 and 3

Serial interface

The SCT smart and magnetic card support must provide a secure and verifiable erasure feature to insure no residual keying material exists after keys have been injected or keying material has been discarded or a procedure that requires erasure of said material can be performed and verified to substantive level.

The SCT smart card reader and writer, and the magnetic stripe reader and writer will support both EMV for smart card support, debit cards, credit cards, and ATM cards.

The SCT will be both physically and electronically secure, and will contain an integral security module, with an encryption chip, that offers simultaneous support for encryption and key management functions. The security module works with DES, Triple DES, RSA encryption, and supports Master/Session Key, DUKPT (derived unique key per transaction) and regional key management methods.

The SCT may provide additional features that are not required to secure the HSM as the device may a higher order utility capabilities as performing as a PIN pad in online and offline debit transactions (with security module).

The process of establishing an apparatus and method of enabling the HSM to meet or exceed the X9 key management requirements and establish said HSM as a TRSM.

The system utilizes products that are available in the market and combines them in unique ways to insure that a programmable or herein also referred to as an intelligent HSM that is a TRSM and meets or exceeds the X9 audit requirements.

The system includes the following;

programmable SCT(s) like ones produced by Verifone or one of its competitors that meet or exceed all the SCT requirements defined in this invention.

programmable HSM(s) like the ones produced by nCipher

application(s) written in one or more languages like C, C++ or Java as needed and as is supported by the development tools provided by the SCT manufacturer to extend the products functionality for the purposes of creating unique, and proprietary work products.

Application(s) written in one or more languages like C, C++ or Java as needed and as is supported by the development tools provided by the HSM manufacturer to extend the products functionality for the purposes of creating unique, and proprietary work products.

deployment support for the HSM for secure deployment of application(s) (“executable images”) to the HSM from a trusted producer, using one or more processes or methodologies such as SSL, digital certificates as an example.

deployment support for the SCT for secure deployment of application(s) (“executable images”) to the SCT from a trusted producer, using one or more processes or methodologies such as SSL, digital certificates as an example.

development tool support to insure application(s) (“executable images”) can access the cryptography of the HSM

smart card(s), serial interface, network interface or other secure I/O interface to transfer keys and executable images to the SCT.

smart card(s), serial interface, network interface or other secure I/O interface to transfer keys and executable images to the HSM.

Policies and procedures for each mode of operations, such as administration, development, testing, deployment and operations for the HSM, insuring said HSM meets the X9 audit requirements.

Policies and procedures for each mode of operation, such as administration, development, testing, deployment and operations for the SCT, insuring said SCT meets the X9 audit requirements.

ACL, password management, smart cards to control access to the HSM for each mode of operation, such as administration, development, testing, deployment and operations of the HSM, insuring said HSM meets the X9 audit requirements.

ACL, password management, smart cards to control access to the SCT for each mode of operation, such as administration, development, testing, deployment, and operations of the SCT, insuring said HSM meets the X9 audit requirements.

With software-based cryptography all of the cryptographic components (i.e., algorithm, key, cleartext, ciphertext) reside in unprotected memory, where they are susceptible to duplication, modification, or substitution. The most susceptible element is the cryptographic key. A duplicated key allows an attacker to recover all encrypted data. In addition a duplicated asymmetric private key allows an adversary to falsely generate digital signatures that would be attributed to the computer owner. A substituted or modified public key would allow a “man-in-the-middle” attack such that the adversary could intercept and change e-mails or transaction data undetectable by the sender or receiver In the hardware-based cryptography on the right, the brick wall represents physical and logical barriers where data is allowed to pass while the algorithm and key are kept secure in the protected memory of a TRSM (“tamper-resistant security device”). Thus, hardware based cryptography ensures the confidentiality, integrity, and authenticity of cryptographic keys and, further, provides assurance regarding the integrity and authenticity of the cryptographic algorithm, which reinforces the overall level of security.

The system insures that the key management policies, practices and lifecycle controls which deal with an organization's policies and practices regarding the management of private asymmetric keys, symmetric keys, and other types of keying material (e.g., pseudo-random number generator seed values), including cryptographic hardware management. Key management life cycle control information should be disclosed to allow relying parties to assess whether the organization maintains sufficient controls to meet its business requirements and insure key generation practices, such that cryptographic keys are generated in accordance with industry standards, including:

Random or pseudo-random number generation

Prime number generation

Key generation algorithms

Hardware and software components

Adherence to all relevant standards

References to the key generation procedural documentation Key storage, backup, and Asymmetric private keys and symmetric keys remain secret and their integrity and authenticity is recovery practices retained, including

Key separation mechanisms

Hardware and software components

Adherence to all relevant standards

References to key storage, backup, and recovery procedures

Business continuity management documentation Key distribution practices Secrecy of asymmetric private keys, symmetric keys, and keying material, and the integrity and authenticity of all keys and keying material are maintained during key distribution, including:

Initial key distribution processes

Subsequent key replacement processes

Key synchronization mechanisms

Adherence to all relevant standards

References to the key distribution procedural documentation

The system relies on the HSM not just for security by also to insure the cryptography which is CPU intensive is optimized for High scalability and is capable of supporting diverse applications. The system and its use will dramatically increase the number of cryptographic keys generated, distributed, installed, used, and eventually terminated. This proliferation will stress the scalability of key management software and the key storage mechanisms that will be forced to manage more and more cryptographic keys.

Millions of users of the World Wide Web rely on a single cryptographic protocol, SSL, to make secure connections to remote web servers. The flexibility and ease of use of SSL, which is built into browser and server software, gives them confidence in the security of their data. SSL is widely used and trusted, even by web users who are not aware of the details of how it works to secure their data. Despite this confidence, the flexibility of SSL potentially leaves companies and their customers at risk. The SSL protocol does not mandate minimum key lengths to be used during the critical initial key exchange that begins each secure session. All too many servers still use insufficiently secure long-term keys. While nearly all modern web browsers use sufficient security for the bulk of the data communication in each session, SSL allows for a variety of key lengths to be used in the key exchange process and it is this which creates risk. The risks of using “short”, 512 bit keys for the RSA encryption phase used to exchange the keys used in each SSL session. It describes the nature of the security provided by the cryptography which underlies SSL. It then examines the various choices available to web server operators, looking at both the historic and current factors affecting those choices, and evaluates the effect that these choices have on the overall security of the system. SSL has many factors in its favor as a means of securing web traffic between browser and server. However, the results of an attack in which the RSA key used at the start of secure sessions could be devastating to the victims. With the increase in computer power over the last few years, the means to carry out such an attack are within reach of a determined and technically competent attacker.

Before the Internet changed the ways we communicate, cryptography, codes and ciphers were the province of government secrets, of a James Bond world where valuable but dangerous information was scrambled to ensure that it remained ‘For your eyes only’.

For the rest of us, the seal of an envelope was sufficient proof that our mail had not been intercepted or tampered with.

With the advent of the Internet, we could not be so confident about the privacy or secrecy of our communication. As data—whether it's personal correspondence, company trade secrets, financial data or our grocery shopping list—travels across the Internet, it passes through many computers. Because it is digital data rather than sealed pieces of paper, we have no way of knowing how many people have seen it, copied it, or had access to it.

That is, without the security provided by the advanced cryptography which is now an everyday feature of many Internet services. Cryptographic security systems provide confidentiality, message integrity, authentication, and non-repudiation.

Cryptography is the ideal solution for ensuring privacy and security on the Internet. The computational power of both the host server and the user's PC can be used to generate the codes used to scramble data so that it can only be read by a recipient who has received the correct code or key to decrypt it back into its original form.

By using long numbers and complex mathematical formulae to generate the keys used to secure data, a high level of security can be achieved. The codes are sufficiently secure that even a powerful computer could not guess them—though the science of cryptanalysis is devoted to using computers to crack codes and find weaknesses in cryptographic systems. In fact, the scrutiny of security systems ensures that weaknesses in proposed systems are found quickly, and that systems are based on standards which have undergone long term, detailed analysis and testing are likely to be more secure than proprietary systems which have not been attacked and tested.

The simplest forms of computer-based cryptography are secret key systems. Here, the same key is used both to encrypt (scramble) and decrypt (unscramble) the data. Both the sender and the recipient therefore need copies of the same keys. Secret key systems employ shorter key lengths, requiring less processing, making them particularly suitable for handling the encryption of bulk data. With secret key security, the risk of data being read is transferred to the risk of the private key being discovered or exposed. Security efforts must therefore focus around creating an architecture that keeps the key secret and safe, and a method of distributing keys which is also safe and secure.

In practice this means that private key cryptography is used to secure communications between two parties who have already established a trusted relationship, or a separate secure communications channel. Algorithms (mathematical methods) used for private key cryptography include DES (Digital Encryption Standard), triple DES and the new AES or advanced encryption standard. This new algorithm has recently been developed to overcome the problem that computers have now become so powerful that they are potentially able to crack or decode DES keys that are used in real-life settings.

Public key cryptography is a more recent innovation—it was first used commercially during the 1970s, and has now become the mainstay of Internet security architectures. Public key systems rely on a related pair of keys, one of which is kept private and used to decrypt data (the private key), and one which is made publicly available and used to encrypt data (the public key). The ability to make the public key widely available makes it much easier to exchange information with people regardless of whether or not you have established a trust relationship. This will be the case for all organizations wanting to use the Web to communicate and transact with hundreds, thousands or even millions of customers or users. Public key algorithms in common use include RSA, which creates pairs of keys from the prime factors of very large numbers, and elliptic curve cryptography, which uses keys derived from the mathematics of complex curves. A significant consequence of using complex numbers is the strain placed upon the computers that encrypt and decrypt data. This can severely impact the performance of cryptographic systems, such as secure Web servers, and has led to a growing market for cryptographic acceleration products.

Again, public key systems rely on the security of the private key. The level of protection required depends on the level of risk involved. For anyone handling very high value information or large volumes of sensitive data, software protection alone is not enough. In these situations the keys are usually stored in a hardware security module where they are only accessible to authorized users and systems.

By combining public and private key cryptosystems, it is possible to overcome some of the disadvantages of each. The main Web security system, Secure Sockets Layer or SSL, uses both secret keys and public keys to establish secure connections between the host Web server and many separate client browsers. Public key pairs are used to set up a secure session, and then data is exchanged using a secret key system. This provides both the security and authentication processes associated with public key systems, and the bulk data encryption capabilities of secret key systems. PGP, another well known security system used by computer enthusiasts to encrypt their email, is another example of a hybrid system which uses both secret key and public key algorithms.

One of the most important current uses of cryptography is to identify and authenticate digital information, so that it can be proved that a particular person sent a particular message, and that it had not been tampered with in transit. Public key systems are used to authenticate messages, so that the recipient can be assured that they came from the supposed sender, and the sender cannot deny or repudiate having sent the messages.

Because only the sender has the private key, any message which the public key can decrypt must therefore have been sent by the holder of the private key. That person has therefore, effectively signed it—as long as the private key is safe. While encryption by a private key in a public key system is the equivalent of signing the document, most public key systems add additional features to a signature such as time stamps and other security codes to prove that the document is genuine.

Digital certificates are special documents that prove that a digital signature is valid.

Certificates are issued by ‘Trusted Third Parties’ or certification authorities, which generate the public and private key for the user, and maintain a directory of issued certificates. When a message with a certificate is received, the recipient can check with the certification authority that the certificate is genuine and that they can therefore trust the message. This process requires the establishment of an infrastructure for it to be useful. It must be simple and instantaneous for the recipient to check a certificate's validity with the certification authority. Lists of valid and invalid (revoked) certificates must be secure but accessible to the service's users. If the public key infrastructure is to be useful outside the confines of a single organization, there needs to be an over-riding system so that certificates can be cross-validated by different systems.

The risk in these systems is concentrated in the central servers which issue and validate certificates. If the underlying private key (the root key) is compromised, none of the certificates, which it has been used to sign, can be trusted. Certification authorities therefore use the strongest possible physical and logical security arrangements to guarantee the security of their own keys.

Thus the risk is transferred from the problem of securing the data to the problem of securing and managing keys. Fortunately, hardware security modules can be used with key management software to provide additional security to protect the keys so that they cannot be stolen. By using a layered security approach you can ensure that there is no single point of failure as there are several systems, physical security devices, software and operating procedures, protecting the keys.

Cryptography is not magic. It does not remove the risk that data can be intercepted, but moves the risk to an area of a system which can be protected more easily. Cryptography only provides security when used as part of a well-designed architecture which has been designed to protect the known areas of risk. The security of private keys is of particular importance, and these are usually stored in special secure hardware modules.

Standards are particularly important in cryptography because they guarantee that a system has been peer-reviewed and tested. All systems have weak points, but those of well understood public key systems are known and have been worked around. New algorithms such as AES have undergone testing by researchers and industry experts to expose any potential problems. Cryptography is one area where novelty does not necessarily equate to improvement, and users should beware of claims made on behalf of untested technologies.

The Secure Socket Layer, or SSL, is one of the most widely deployed cryptographic protocols. It is built into all the major web browsers, which gives it an installed base of over 400 million users. At the time of writing there are over 140,000 web sites offering SSL connections with valid server certificates3. An analysis of the length of keys used by over 137,000 of these sites reveals that over 19%—26200 individual web sites—are using keys that are too short to be safe.

The SSL protocol has been in use since the mid-1990s. It has evolved over the years as a result of a number of influences, both technical and non-technical. The use of cryptography has historically been highly regulated by governments, both in terms of the strength of cryptography that can be used domestically and the strength of cryptographic products that can be exported. Both export and domestic controls have resulted in compromises in the key lengths used by some SSL systems. These still have an effect, even though the regulatory environment has changed greatly in the last few years and many of the original restrictions have now been lifted.

By understanding what SSL sets out to do, and how system administrators implement it, it becomes possible to understand why certain ways of using SSL fail to deliver the required security. Once these weaknesses are apparent it becomes clear that they can be corrected.

The SSL protocol sets out to perform three separate functions, and uses three separate classes of cryptographic algorithm in the process. The three functions are:

Identification and authentication of the parties involved

Protection of the confidentiality of the communication

Protection of the integrity of the message data.

These goals are achieved with a combination of public key cryptography, symmetric (or secret key) cryptography and message digests.

Authentication. The first function of SSL is to allow the client to identify the server as being a particular machine and optionally allow the server to identify the client. This is achieved using public key encryption and a digital certificate issued by a trusted Certificate Authority (CA). The most common cryptographic algorithm used in this phase is the RSA algorithm4, although later versions of SSL allow or other algorithms to be used.

In practice essentially all SSL traffic in and out of public web servers is authenticated with RSA keys, because this enables the authentication process and the first part of the confidentiality process to be rolled into a single operation, known as an authenticated key exchange.

Confidentiality. The second function of SSL is to keep the communication confidential. This is usually performed using a symmetric encryption scheme. The problem with symmetric encryption is that both of the parties involved need to share a secret key, whereas with public key encryption the sending party only needs to know a publicly known encryption key belonging to the receiver. Public key encryption is not used for the bulk of the communication, since it is up to 1000 times slower in operation than symmetric encryption. In SSL, public key encryption is used to exchange a secret; once both parties of the connection know this secret, the bulk of the data is encrypted and transferred using these shared secret keys and a symmetric algorithm. Since the RSA algorithm allows the authentication and the key exchange to take place in a single operation its use allows the whole protocol to run significantly more quickly than the alternatives. Once the key is exchanged the vast majority of web traffic is encrypted with a symmetric cipher known as RC4, although most browsers allow for other options. Again, the reason for this is that RC4 is an extremely efficient cipher.

Integrity. The third function is to ensure the integrity of the data against tampering. This is performed using message digests. The MD5 and SHA-1 algorithms are used to compute a complex function based on both the message that was sent and the secret values known only to the machines at each end of the connection. The receiving machine computes the same function on the data that arrives. If the value computed at each end matches then it can be sure that, as long as the secret key was correctly exchanged, only the client at the other end of the SSL connection could have computed that function.

These three functions are interdependent. Since the authentication phase is also used to deal with the key exchange, any compromise of this process would also compromise the confidentiality and integrity of the communication. Since a single key used in the initial authentication phase underpins all three functions, any compromise of that key compromises every aspect of the security of SSL.

Whenever considering a security threat, one must both consider both the likelihood of the attack being carried out and also the effect of the attack. By evaluating the costs of potential attacks and the likelihood of them happening, compared with the costs of preventing the attack and operating extra security measures, one can decide whether it is worth protecting a site against a particular set of risks. If the total cost of potential damage from some type of attack is small, and the risk of it happening is low, the costs of preventing that type of attack may not be worth the investment required. So what happens if an attacker gains possession of your RSA key? Do the risks here outweigh the effort required to prevent the attack? To answer this we need to remind ourselves of what the RSA key does in SSL. It is used in two ways:

to authenticate the server to the user

to ensure that communications to and from the user are confidential.

Because the RSA key is used for authentication, if your web server's RSA key is available to an attacker, then that attack can produce a replacement web site that claims to be yours. Visitors attempting to reach your site would be driven to the bogus, substitute site. If this happens, the end user will be presented with what appears to be incontrovertible evidence that the site is yours, because the RSA key will authenticate it as being genuine. This bogus site could:

destroy the trust between your customers and your business

offer incorrect or fraudulent information,

encourage your users to hand over personal or financial information to the attackers thinking that they are giving the information to you,

damage the goodwill in your business or even destroy your reputation.

Clearly the potential risks caused by an attack that enables a malevolent outsider to substitute an impostor web site for yours and destroy your customer relationships are serious and the cost to you of such an attack would be high. Besides authentication, the other function of the RSA key in SSL is to ensure the confidentiality of the data. If an attacker has your RSA key then they can potentially decrypt all the traffic that is going to your server, if they can intercept it. Worse, they could have been recording your traffic for months and retrospectively decrypt all the past traffic5. All the data that has ever passed through your server under the protection of the stolen key has its confidentiality compromised, and all future traffic will be compromised until you realize that this has happened and changed the key.

Of course, the attacker could do both of the above, that is destroy your good name by replacing your site with one that misrepresents you, while retrospectively gaining access to all the data your users have communicated with you in the past. It would be difficult for an online business to recover from such a serious breach of trust. Now that we understand the impact of some third party gaining access to your private key we need to look at the probability of such an event happening, so that we can make a realistic assessment of the overall risk. To do this we need to understand the reasons for, and the impact of, the widespread use of short RSA keys in SSL. In cryptographic terms, SSL has no “forward secrecy” when using RSA keys.

When the SSL protocol was invented in the mid-1990s by developers at Netscape, the United States still had tight export controls on encryption technology. The US government had, since the start of the cold war, treated encryption systems as a munitions. Because of this, US companies could only export systems that used SSL if they had a special export license. The Bureau of Export Administration (BXA) relaxed these controls to allow the export of software that used weaker forms of encryption. In particular, in the context of SSL, both server and browser applications were limited; they could use:

Symmetric (secret key) ciphers with a key length of 40 bits or less

Asymmetric (public key) ciphers with key lengths of 512 bits or less

Netscape and other server vendors built export versions of their servers with shortened key lengths and were allowed to sell them world wide6. In addition, some countries (notably France and Russia) instigated domestic controls on the use of cryptography and limited the use of asymmetric keys in web servers to 512 bits. With all the major commercial vendors of SSL capable web servers limiting the strength of the cryptography they sold outside the US a number of things happened. At first, the number of secure servers in use outside the US went up, but they tended to use weak encryption. Later, two Australian programmers in Australia released a public domain implementation of the SSL protocol called ssleay. Since Australia did not limit the export of public domain software their implementation rapidly became widely used in a number of systems including the popular public domain web server software, Apache. With the widespread availability of strong encryption in a freely available (and cost-free) web server, the commercial server vendors spent much of the late 1990s applying pressure to governments to further relax the controls on the export (and use) of cryptography. By the year 2000 most countries allowed the export of “commodity” software that contained encryption, no matter how strong. Technical and performance issues It should be noted that there is another reason why some server operators used weak encryption. As described above, public key encryption is not used to encrypt bulk of the data in an SSL session, because it is very slow. Not only is public key encryption slow, but the speed of encryption and decryption is related to the key length by a cubic function. If the key is two times longer, then the decryption takes 2×2×2=8 times as long. Conversely, if you make your private key half the length it was then the decryption runs eight times faster. Once many government controls on cryptography were relaxed, it might be expected that the sites using weak encryption for their SSL would immediately move to more secure key lengths.

Unfortunately a combination of inertia, a general conservatism regarding changing working software set-ups and concerns about performance have led to a large number of secure web servers continuing to run with short keys. Our analysis of the server keys used by some 137,000 ‘secure’ sites included in the Netcraft survey found that 19.2% of them where using keys shorter than 900 bits long and 18.8% were using keys less than 640 bits long9. One commercial web site was accepting credit card details over the Internet using SSL secured with a 384-bit RSA key. There were, and still are, limitations regarding selling even very weak cryptography to countries that are thought to sponsor terrorism.

The programmers, Eric Young and Tim Hudson, subsequently left the project and it was renamed OpenSSL. It is available at www.openssl.org See http://www.apache.org/

It is interesting to note that some countries rely on weak encryption more than others do. Taiwan, Israel and France all have over 40% of their supposedly secure servers running on short keys, and Japan and the United Kingdom, while slightly better by percentage, each have close to 2,000 SSL servers in active use with short keys. In fact most European countries have a third or more of their commercial servers running with short keys and the ones that do not tend to have very low numbers of secure servers, making accurate accounting difficult.

Breaking the RSA cipher in the general case (for example, deriving the private key from the public key) is equivalent to the problem of factoring the modulus used in the encryption process. The problem of factoring a large composite number is hard, but mathematicians have yet to agree just how hard this is. The problem is one that has been being considered for centuries and in the last few decades much progress has been made.

Currently the best known method of factoring the sort of numbers used for RSA encryption is the General Number Field Sieve (GNFS). This algorithm has successfully been used to factor a 512-bit number. In 1999 an international group of cryptographic researchers demonstrated the effectiveness of this algorithm when they factorized the RSA-155 Challenge, a 155 decimal digit (512 bit) number that was the product of two primes. The GNFS runs in two phases:

In the first phase, which can easily be distributed across a large number of computers, various numbers are tested in a process known as “sieving”.

In the second stage the results of all the distributed processing are brought together to yield the factors of the number being tested.

This is the case since (a) if one can factor the modulus one can trivially derive the private key and (b) if one has both private and public exponents one can easily factor the modulus. On the occasion of the RSA-155 challenge it took 35.7 CPU years12, or about 8000 MIPS years13 of processing for the distributed part. The work was done with mixture of computers with CPU speeds ranging from 175 MHz to 500 MHz. Once all the data from the distributed computation was collected it took another 224 CPU hours on a Cray C916 supercomputer with 3.2 GB of main memory to complete the process and produce the factors. In the three years that have elapsed between the start of that research the speed of typical CPUs has increased. Moore's Law has historically been fairly accurate and would suggest that the performance of computers will have gone up by about a factor of four. Taking a conservative estimate, a similar factorization could be expected to take about 10 CPU years of distributed work. Now consider the resources available to the average system administrator of a medium-sized company. 200 PCs sit on desks; they are networked together and they are mostly idle for 16 hours a day. With this level of resource, the data collection for factoring a 512-bit number would take less than a month. The supercomputer phase still needs to be carried out, and most people do not have easy access to such a machine. That said, the main reasons for using a supercomputer were to minimize the elapsed time (with many CPUs it took less than 224 hours to complete), and also because in 1999 it was hard to find machines with that much physical memory. Using virtual memory for this type of computation would have slowed the process by several orders of magnitude. However, if someone were to carry out the same computation now they could use an off-the-shelf server containing, for instance, an Intel Itanium processor. 4 GB of physical memory these days can be bought for less than $500. Indeed, a research student of the author recently implemented the matrix reduction parts of the GNFS on the Itanium and showed that, with sufficient RAM to hold the entire matrix data, the results of sieving a 512 bit key could be processed in about three weeks. So, the breaking of 512-bit RSA is easily within reach of any mathematically adept individual with access to the level of computing resources available in most medium-sized businesses. This does not represent a very high barrier for a determined attacker. The computational requirements of the GNFS algorithm as a function of the key length vary in a very complex manner14. Due to the complex nature of the complexity function itself there are no firm figures around for the computational effort needed to factor a 1024-bit number. However, it is generally accepted that to do this will be between 1,000 and 10,000 times harder than factoring a 512-bit number, just for the distributed part of the algorithm, and then the collected data will probably run to between 10,000 and 100,000 times as much as before. This is currently well beyond the computational capacity of anyone other than the security agencies of rich nations and even then they would find it difficult to factor more than a handful of keys a year. There has recently been some debate about the practicality of factoring 1024 bit keys but there is little or no evidence that these proposed advancements will make a difference to those for whom the expected attacker is not a well funded government. It will probably be 15 years or more before such an attack comes within the realms of possibility for rich corporations and casual attackers will be some way behind them. Given the speed with which technology moves on it seems likely that 1024-bit keys will serve SSL very well, until SSL itself is superseded by new technology at some point in the future.

Gaining access to encrypted information can occur on two fronts. First there is the ability to factor the private key, from the public key. This process becomes more and more difficult as key length is extended as has been discussed. The other option is to steal the private key. This option becomes more and more attractive as the RSA key length is increased, making successful factoring less likely. Although many organizations take care to use medium to long RSA keys, they often neglect to secure the private key from direct attack or theft. The keys are left exposed on a server along with the data they are meant to protect. Best practices dictate securing the keys in a FIPS 140 compliant hardware security module (HSM). This module integrates into the server and becomes a secure subsystem, which generates keys and performs all cryptographic functions securely, never exposing the keys in usable format. As noted above, increasing key length can have a dramatic effect on system performance. A hardware security module can also provide performance improvements by off loading cryptographic processing from the server, resulting in accelerated system performance. Conclusions SSL has many factors in its favor as a means of securing web traffic between browser and server. However, if the RSA key used at the start of secure sessions is compromised, the results could be a devastating attack to the victim. With the increase in computer power over the last few years, the means to carry out such an attack are within reach of a determined and technically competent attacker. Given this, the use of short (512-bit) RSA keys for SSL should be abandoned in favor of longer keys. In countries where short keys have been widely used for regulatory reasons, Internet commerce over a high proportion of sites should not be regarded as secure. Any business that values its customers and its reputation should ensure that its web site is using at least 1024-bit long RSA keys for its SSL encryption and protects these keys with a FIPS 140 compliant hardware security module.

Key management is the secure administration of cryptographic keys. A cryptographic key is merely data, a string of binary zeroes and ones that enable a cryptographic algorithm to manufacture “ciphertext” output from “cleartext” input. Cryptographic algorithms can provide encryption and decryption of information for data confidentiality, message authentication codes (MACs) for data integrity and entity authentication, as well as digital signatures for data integrity, entity authentication, and non-repudiation. Cryptography is also used in key management to achieve the confidentiality, integrity, authenticity, and non-repudiation of cryptographic keys, which is an integral part of sound key management practices. There are several ways to securely handle keys and other relevant keying material, and there are even more ways to mishandle and mismanage cryptographic keys. Improper key management is a constant threat to any application employing any form of cryptography, which dramatically and unnecessarily increases business risk. With the advent of public key cryptography, effective management of keys has become even more important, particularly in the case of management of private keys when integrity and authenticity must be provable to a third party (i.e., non-repudiation). A new community of users and integrators is relearning the importance of hardware-based cryptography and the importance of formal security evaluation and compliance testing.

Historically, symmetric cryptography (dating from Egyptian hieroglyphics circa 1900 B.C. to more recent use in World Wars I and II circa 1900 A.D.) required that the same cryptographic key, which must be shared between two communicating parties (i.e., the sender and the receiver), be securely exchanged using manual procedures. Today, symmetric keys are distributed electronically from the key-generation point to the operational sites by enciphering these keys with other symmetric keys called key enciphering keys (KEKs). The primary issue with symmetric key management schemes is establishing the first KEK, commonly called the initial key.2 The initial key, in order to maintain its confidentiality, is typically generated and securely exchanged as multiple key components. An organization must designate trusted individuals as key agents, with each key agent assigned a single key component. When all the components are securely combined under the supervision of a security officer, the symmetric key is recreated securely, so that no one individual has ever viewed or had access to the symmetric key. This labor-intensive process is still used in today's financial systems.

The advent of asymmetric or public key cryptography provided a partial solution to the initial symmetric key problem. A symmetric key can be randomly generated by the sender and encrypted using the public key of the receiver. The receiver can then decrypt the enciphered symmetric key using his or her own private key. Clearly, this simplifies the process for exchanging the initial symmetric key, however it introduces to the sender issues regarding the integrity and authenticity of the receiver's public key. Previously, the symmetric key manual procedures implicitly provided integrity and authentication between both parties. Assurance concerning the integrity and authenticity of a receiver's public key can be enhanced by using public key certificates, whereby the receiver's identity is cryptographically bonded to his or her public key. In this key management practice, the sender relies on the receiver's public key certificate, which has been issued by a trusted third party called a certification authority (CA). However, life is not so simple as to have one global CA for everyone and everything on the planet. Other issues also affect key management practices. The sheer number of asymmetric key pairs, public key certificates, and symmetric keys is dramatically increasing as cryptography proliferates in network infrastructures, remote devices, and business applications. Furthermore, cryptographic keys do not last forever; they must be periodically and

securely replaced. The scalability and extensibility issues regarding key management are creating new challenges that could very well result in new and interesting problems and innovative solutions.

There are several universal key management controls that must be

enforced throughout the key life cycle.

Private asymmetric keys and symmetric keys shall only exist in the following secure forms:

As cleartext inside the protected memory of a tamper-resistant security module

As ciphertext outside the protected memory of a tamper-resistant security module

As two or more key fragments (e.g., key components, k-of-n key shares), either in cleartext or ciphertext, managed using dual control with split knowledge

These three forms ensure that the confidentiality of private asymmetric and symmetric keys is absolute; no one must ever know these keys.

Public asymmetric keys are unrestricted by definition; therefore their confidentiality is not necessary; however, the integrity and authenticity of public asymmetric keys must be established, maintained, and verifiable. Public key certificates bind the user's identity to the public key via the CA's signature on the certificate, and therefore ensure the integrity and authenticity of the certificate contents, including the public key it contains.

Key generation should use only approved algorithms (e.g., X9 standards) for random or pseudo-random number generation and random prime number generation.

Key separation is a security method whereby each key (or key pair) is generated for a particular purpose and is used for the sole purpose for which it was intended.

Key synchronization is the ability to verify that the same key (e.g., symmetric or asymmetric private key) is securely stored in one or more locations without compromising the security of the keys or the systems.

The ANSI X9 and ISO standards for symmetric key management have been established for over ten years, with revisions every five years per the ANSI procedures, or on an as-needed basis (e.g., X9 standards using single DES encryption have either been withdrawn or revised to triple DES encryption). Similarly, many ANSI X9 and ISO standards for asymmetric key management have been recently published or are in progress. In parallel to the X9 standards, auditing standards for certification authorities (CAs) relating to asymmetric key management have also been published. The financial services industry often leads the development of standards regarding key management techniques and has established the ability to validate compliance against those standards. The American National Standard (ANS) X9 Technical Guideline #3 (TG-3) PIN Audit Security Guideline was adopted by the Electronic Funds Transfer Association's (EFTA) Network Executive Council (NEC) so that electronic funds transfer (EFT) networks could agree on a common set of personal identification number (PIN) and key management criteria. Most of the EFT networks require their members to periodically undergo a TG-3 examination either by their internal auditors or a third-party accounting firm. X9 TG-3 addresses PIN and related key management security controls based on two other American National Standards, X9.8 PIN Management and Security and X9.24 Financial Services Key Management Using Symmetric Cryptography. Recently, the PKI Forum12 endorsed the ANS X9.79 PKI Practices and Policy Framework standard and the corresponding document from the American Institute of Certified Public Accountants (AICPA) and the Canadian Institute of Chartered Accountants (CICA), the WebTrustSM/TM Program for Certification Authorities. These companion standards enable an experienced practitioner to perform an examination of the controls implemented by a certification authority (CA). A large portion of the controls described in these standards address the CA environmental controls and the key management controls. The AICPA and the CICA issued a press release in May 2001 announcing that the Microsoft® Corporation selected the WebTrust SM/TM for Certification Authorities (or its equivalent) as part of its program for accepting CAs wishing to distribute their root certificates through Microsoft software. Key management has become an integral part of the ISO and ANSI standards, and is now being integrated into industry and accounting standards.

Split Knowledge A condition under which two or more parties separately and confidentially ANS X9.8, have custody of components of a single key that, individually, convey no ANS X9.24, knowledge of the resultant cryptographic key. ISO 11568

Tamper Evident, a characteristic that provides visual evidence that an attack has been ANS X979, wherein Tamper Resistant being a characteristic that provides passive physical protection against attack.

PIN Personal identification number is a 4- to 12-digit number used by financial ANS X9.8, institutions to authenticate their customers at an ATM for cash withdrawal ISO 9564 and at POS devices for debit transactions

KEK Key enciphering key is a symmetric key generated and used for the sole ANS X9.24 purpose of protecting other symmetric keys (e.g., master key, session key). ISO 11568

MAC Message authentication code is an integrity value that is cryptographically ANS X9.9 derived from a message so that the modification or substitution of either ANS X9.19 can be detected. ISO 16609

Ciphertext Data in its enciphered form. ANS X9.24 ISO 11568

Cleartext Data in its original, unencrypted form. ANS X9.24 ISO 11568

DES Data Encryption Standard is the Federal Information Processing Standard www.nist.gov

DEA (FIPS) Publication 46-1 that defines the data encryption algorithm (DEA). The DEA is also described in ANS X3.92.

Dual Control A process of using two or more separate entities (usually persons) operating ANS X9.8 in concert to protect sensitive functions or information whereby no single ANS X9.24 entity is able to access or use the materials (e.g., cryptographic key). ISO 11568

The system provides a method of using Debit and ATM cards as non-reputable form of authentication. Financial institutions that issue debit and ATM cards on bank accounts establish customer identity in a face-to-face encounter. Subsequent identify verification occurs when the subordinate checking, money market, or savings account is established, Customer identity verification may be performed by the financial institution using standard personal identity verification protocols, including social security number, passport, drivers license or other legally binding forms of identification.

Wherein online debit, which is the use of a debit or ATM card with a PIN is a real-time, non-reputable authentication of identity, and upon completion of any transaction even a balance inquiry is considered authentication.

This system claims use of the application of Online Debit as a non-reputable means of authentication for the issuance of digital certificates for purposes of identity authentication, credential authentication, the embodiment of e-sign, authentication of identify on financial transactions including credit, checks, online checks, EBPP, online banking.

Authentication is the process of proving your identity. One of the most common methods of authentication in use today is the username/password pair. This is a kind of authentication process that most of us are familiar with when we use our ATM card at the bank. First you insert your card into the ATM, analogous to entering a username. You then enter a PIN, or password, that only you and a trusted server in the bank network know, and you have proven your identity to the bank machine. By proving your identity, you, and hopefully only you, can now make withdrawals from and deposits to your account.

In the course of a day, you may have to use one username/password pair to log in, or authenticate, to read your email, and later in the day use another password to log in and update your personal Web page.

Authorization is the process of determining what you are allowed to access. Again using the ATM example, by inserting your card and then entering your password, you have authenticated yourself to the bank's ATM service. However, you are only allowed to make deposits to and withdrawals from your own account. In other words, you are authorized to modify only your account. The true strength of authorization is in the ability to extend beyond a single account. Many banks now offer the ability to transfer money between several accounts. You may want the ability to transfer money from your account to a son or daughter's account while they are away at school. However, you may not want your son or daughter to be able to transfer money out of your account. Although each of you can independently authenticate to the ATM with your own card and password, you are each authorized to access different accounts. Though you have access to your son or daughter's account, your child does not have access to your account.

Combining a single authentication process with a shared authorization system for access to information is the key. Two-factor authentication technology is used daily at ATMs where customers need both their PIN number as well as the magnetic strip card. Even if someone obtains the PIN number, the card is also needed for access.

The present system uses a software interface that protects the password and PIN securely from the consumer's terminal (computer), through the Internet, directly to the financial institution, without any third party or merchant having access to the information. It is a robust authentication and authorization scheme for over one billion people in the world who currently have a bank account and PIN number already issued in a secure manner.

The present system then adds important terminal verification procedures, geo-location software that detects the location of the terminal to a higher degree of accuracy.

The present system is further capable of defining different levels of authorization, or classes, that provide the appropriate services to users. An authorization system can perform identity authentications based upon the additional information banks have when they do their-to-face-to-face authentication to open an account.

The present system provides for the identification of the BIN as captured by software, a POS or ATM device for the express purpose of payment processing or authentication.

The system's BIN identification allows for mapping of the issuing bank for the BIN to the financial institutions primary EFT relationship, wherein such relationship management allows for Least Cost Routing and Least Cost Processing for said BIN.

The system's BIN identification allows for mapping for the BIN to the financial institutions brand image, wherein such relationship management allows systems that can dynamically display images to create an active or static image of the Bank on the acceptance device, either proportional to the actual card or as a logo. Additionally said process will also identify the EFT provider for the transaction and update the card image with the approved EFT logo for that EFT processor.

The system maintains usage records on BIN and PAN providing for an active risk management scheme, wherein velocity by BIN, PAN and Merchant, wherein velocity is managed by transactional volume, transactional amount, and aggregates totals for both, provides an active fraud and risk mitigation system.

PAN is number identifying the cardholder and the card issuer. Typically, this number is embossed on the front of the card and encoded on Track 2 of the magnetic stripe.

The remainder of the description refers to a PAN that conforms to the ISO/IEC 7812 specification.

The PAN is made up of 3 components. These are the issuer identification number (IIN), the individual account identification identifying the customer and a check digit. The IIN is made up of 2 elements: the major industry identifier (MII) and the issuer identifier. The MII identifies the major industry of the card issuer and can contain one of the following values:

| M Description | |
|---|---|
| MI | |
| MI | Description |
| 0 | For assignment by ISO/TC 68 |
| 1 | Airlines |
| 2 | Airlines and other future industry |
| | assignments |
| 3 | Travel and entertainment (e.g. |
| | Diners Club) |
| 4 | Banking/financial (e.g. Visa) |
| 5 | Banking/financial (e.g. MasterCard) |
| 6 | Merchandising and banking (e.g. |
| | retail private label cards) |
| 7 | Petroleum |
| 8 | Telecommunications and other |
| | future industry assignments |
| 9 | For assignment by national |
| | standards bodies |

The issuer identifier is normally a fixed length five-digit number. Historically the first digit was used to indicate the length of the issuer identifier. However, all new numbers are issued as fixed length five-digit numbers.

The individual account identification is assigned by the card issuer and identifies an individual customer account. It is variable in length with a maximum of 12 digits.

The check digit is the last digit of the PAN and is calculated on all the preceding digits of the identification number using the Luhn Formula for a modulus 10 check digit.

In the case of Visa Cash transactions (with the exclusion of a Visa Cash Funds Request), this field contains the Visa Cash Card Number. This is a fixed length field consisting of 3 data elements:

Visa Cash Card Issuer BIN (positions 1-6)

Visa Cash Serial Number (positions 7-15)

Visa Cash Check Digit (position 16)

Luhn Formula: Double the value of alternate digits beginning with the first right-hand digit (i.e. low order). Add the individual digits comprising the products obtained in step 1 to each unaffected digit in the original number. Subtract the total obtained in step 2 from the next higher number ending in 0. If the total obtained in step 2 is a number ending in zero, the check digit is zero.

Example: The check digit for a PAN (excluding check digit) of 4992739871 is 6, calculated as follows:

| Steps | Calculation |
|---|---|
| 1 & 2 | 4 + (1 + 8) + 9 + (4) + 7 + (6) + 9 + (1 + |
| | 6) + 7 + (2) 64 |
| 3 | (000393) 70 − 64 6 |

TRACK 1

The information encoded on Track 1 of the magnetic stripe as defined in ISO 7813, including field separators but excluding the begin sentinel, end sentinel and longitudinal redundancy check characters.

Note that two structures are defined by ISO 7813, namely Structure A and Structure B. Structure A is reserved for proprietary use by card issuers, while Structure B is defined as follows:

| Field | Length |
|---|---|
| Format Code | B (ASCII 66) |
| Primary account | up to 19 digits |
| number | |
| Field separator | 1 character (ASCII 61 or 94) |
| Country Code | 3 digits (or a field separator if not present) |
| Name | 2 to 26 characters (this field is further described |
| | below) |
| Field separator | 1 character (ASCII 61 or 94) |
| Expiry date (YYMM) | 4 digits (or a field separator if not present) |
| Service restriction | 3 digits (or a field separator if not present) |
| code | |
| Discretionary data | balance of available digits |

The primary account number, expiry date and service restriction code fields are described in further detail under fields 2, 14 and 40 in this document.

The structure of the Name field is defined in the following table. Sub-fields are separated by means of a space character (ASCII 32). The minimum encoded data allowed is a single character followed by the surname separator.

| Field | Notes |
|---|---|
| Surname | |
| Surname separator | ASCII 47 |
| First Name or Initial | |
| Space | When required |
| Middle Name or | |
| Initial | |
| Period | When followed by Title; |
| | ASCII 46 |
| Title | When used |

The space character (ASCII 32) is required to separate the sub-fields of the Name field other than the surname. The separator terminating the surname should be encoded following the last sub-field of the Name field. If only the surname is encoded, it will follow the surname separator.

The present invention provides for the usage of Debit and ATM cards that require TRACK 2 to be present for successful PIN processing, the process of identifying which financial institutions that are issuing debit and ATM cards to cardholders utilize TRACK 2 for a card present indicator.

The present system recalculates TRACK 2 by acquiring the card issuers DES key, a secret only known by the card issuer, who is in most cases the financial institution that the account holders card is attached, wherein we maintain the confidence of the financial institution by protecting the keying material, and the keys with a KEK and with 100% conformance with the X9 key management standards.

The present system may also replace TRACK 2 in an EFT message by sourcing TRACK 2 from other ATM or POS messages acquired by a switch, processor or EFT network, wherein said data was acquired by processing historical messages as acquired in realtime or offline, from ATM or POS terminals, or provided by same during the process of switching the message though said entity.

The present system may also replace TRACK 2 in an EFT message by contracting the EFT Network, switch or processor who performs stand-in for said card issuer to provide TRACK 2 upon receipt of a message prior to authorization or switching to the authorizing entity.

The present system may also include the decision of the EFT Networks to allow PIN authorization with a PIN database held by the card issuer and thereby waive the requirement for TRACK 2, wherein other authorizing entities, commonly referred to as a stand-in authority and as such eliminate the requirement for PIN OFFSET′ for card present transactions.

This present invention claims preference in changing a fundamental processing requirement, a decision that enables the usage of cards, such as ATM cards which inherently can not be used in card not present conditions, a condition where no magnetic stripe reader is present for usage in mediums that serve consumers from the office or home, wherein no access to a card reader, magnetic stripe reader is possible and therefore without this invention are unable to process payment transactions online.

The system allows obtaining, sourcing, retaining, replacing, substituting and ignoring discretionary data as found on debit and ATM cards magnetic stripe commonly referred to as TRACK 1 and TRACK 2 for both PIN Authentication and verification.

The system may treat all transactions as card present transactions.

As the industry moves to a customer centric and cost reduction perspective the card issuers have come to realize that TRACK 2 did not give them the gain in FRAUD reduction as reading the magnetic stripe on a debit or ATM card can be done with a simple PC and a magnetic stripe reader, and with a little more money the same consumer can duplicate a bank issued card at home.

The process may define the transaction as Manual entry or other as needed to conform with certain networks and banks that have an issue with one or more of the defined methodologies and processes

The authorizing entity, the issuer, the bank, network or other stand-in authority may also ignore the TRACK 2 and other discretionary data and verify the PIN directly using one or more methodologies and processes herein defined and including verification against the clear-text PIN during the authorization process, wherein said PIN was stored in it's encrypted form for offline or online verification.

As a result the card issuers have been moving to a Natural PIN, or the use of a PIN Database which requires no TRACK 2 to be present to authenticate the PIN, greatly reducing the cost of PIN changes and customer support.

The debit and ATM cards issued that require TRACK 2 for PIN processing have a PIN OFFSET value on TRACK 2 that is the cryptogram of the PIN, wherein it's generation is accomplished by combining the PAN of the card, the PIN and encrypting the value using the issuers DES key assigned by the financial institution for that BIN.

The information encoded on Track 2 of the magnetic stripe as defined in ISO 7813, including field separators but excluding the begin sentinel, end sentinel and longitudinal redundancy check characters. The field separator (FS) can be either a “=” or a “D” character. The layout of this field is as follows:

| Field | Length |
|---|---|
| Primary account | up to 19 digits |
| number | |
| Field separator | 1 digit |
| Expiry date (YYMM) | 4 digits (or a field separator if not |
| | present) |
| Service restriction | 3 digits (or a field separator if not |
| code | present) |
| Discretionary data | balance of available digits |

The primary account number, expiry date and service restriction code fields are described in further detail under fields 2, 14 and 40 in this document.

For Visa Cash load transactions, this field contains the Visa Cash load signature data from the chip that is sent to the issuer to allow the issuer to verify the Visa Load Request Signature (S1). The layout of this field is as follows:

| Field | Length |
|---|---|
| Visa Cash card | 16 digits |
| number | |
| Field separator | 1 digit (can be a “=” or a “D” character) |
| Expiry date (YYMM) | 4 digits: Only the YYMM portion of the Visa |
| | Cash expiration date |
| Service restriction | 3 digits (must be “101”) |
| code | |
| Visa Cash balance | 6 digits |
| Transaction number | 5 digits |
| GMT offset | 2 digits |

It will be appreciated by those skilled in the art having the benefit of this disclosure that this system provides a system and method for processing PIN-based transactions. It should be understood that the drawings and detailed description herein are to be regarded in an illustrative rather than a restrictive manner, and are not intended to limit the system to the particular forms and examples disclosed. On the contrary, the system includes any further modifications, changes, rearrangements, substitutions, alternatives, design choices, and embodiments apparent to those of ordinary skill in the art, without departing from the spirit and scope of this system, as defined by the following claims. Thus, it is intended that the following claims be interpreted to embrace all such further modifications, changes, rearrangements, substitutions, alternatives, design choices, and embodiments.

1. A method of performing a PIN authenticated transaction comprising the steps of:
collecting representational data from a terminal;
transmitting the representational data from the terminal to a PIN processor;
processing the representational data to generate a PIN; and
authenticating a transaction using said PIN.

2. The method of claim 1, wherein said terminal is a computer

3. The method of claim 1, wherein said step of transmitting is performed via a network connection.

4. The method of claim 3, wherein said network connection is an open network connection.

5. The method of claim 4, wherein said open network connection is an Internet connection.

6. The method of claim 1, wherein said transaction is a financial transaction.

7. The method of claim 6, wherein said financial transaction is an ATM/Debit transaction.

8. The system of claim 1, wherein said representational data is collected using a mouse interface.

9. The system of claim 1, wherein said representational data is collected using a graphical display of a randomized keypad.

10. A system for performing PIN-authenticated transactions comprising:
a terminal;
a network communicably connected to the terminal;
a secure server communicably connected to the network;
wherein representational data is collected at the terminal, transmitted via the network to the secure server and the secure server processes the representational data to generate a PIN used to authenticate a transaction.

11. The system of claim 10, wherein said terminal is a computer.

12. The system of claim 10, wherein said network is an open network.

13. The system of claim 12, wherein said open network is the Internet.

14. The system of claim 10, wherein said transaction is a financial transaction.

15. The system of claim 14, wherein said financial transaction is an ATM/Debit transaction.

16. The system of claim 10, wherein said representational data is collected using a mouse interface.

17. The system of claim 10, wherein said representational data is collected using a graphical display of a randomized keypad.
